(19) United States
(12) Patent Application Publication
(10) Pub. No.: US 2010/0289845 A1
(43) Pub. Date: Nov. 18, 2010

(54) PRINTER

(75) Inventors: Paul Conway, Dorset (GB); Christian Tamblyn, Dorset (GB); Andy Loveless, Dorset (GB); Andy Pass, Dorset (GB); Jonathan Williams, Dorset (GB)

Correspondence Address: ROBERTS MLOTKOWSKI SAFRAN & COLE, P.C.;Intellectual Property Department, P.O. Box 10064, MCLEAN, VA, 22102-8064, US

(73) Assignee: ULTRA ELECTRONICS LIMITED, Middlesex (GB)

(21) Appl. No.: 12/665,035

(22) PCT Filed: May 6, 2008
(86) PCT No.: PCT/GB08/01561

§ 371 Date: May 18, 2010

(51) Int. Cl. B41J 29/38; G06F 3/12; H04N 1/60; B41J 2/01

(52) U.S. Cl. 347/16; 358/1.15; 358/1.9; 347/101

(57) ABSTRACT

There is disclosed a printer, comprising a print unit for printing on a print medium; a print media reversal unit for reversing the print medium to allow double-sided printing onto the print medium; a memory unit for storing printer configuration data, the printer configuration data including data specifying whether or not the printer is permitted to operate in a double-sided printing mode; an input device for receiving an instruction to permit the operation of the printer in a double-sided printing mode; and a print controller for controlling the print unit and the print media rotation unit, the controller being programmed to operate the printer in either a single-sided or double-sided mode in dependence on the printer configuration data, and to update the printer configuration data appropriately in response to receiving the instruction to permit the operation of the printer in a double-sided printing mode.

### FIELD OF THE INVENTION

The present invention relates to a printer and a method of calibrating a printer.

### BACKGROUND OF THE INVENTION

Many different models of printer are sold worldwide, including different print technologies such as inkjet printing, laser printing and dye sublimation printing.

Printers also have varying functionality. Some are capable of single-sided printing only, for example, and others are capable of double-sided printing. Double-sided printing may be enabled in some cases using a print media reversal unit (also known as a ‘rotation unit’ or ‘flipper’) which takes a print medium as it leaves the main print path, reverses the print medium, and feeds the print medium back into the print path for printing on the second side.

Other functionality includes the ability to imprint printer consumable material (such as laser print toner, inkjet ink or dye sublimation dye) onto different types of print medium. Many printers are capable of printing only onto relatively thin and flexible print media such as paper and thin card. Other printers serving more specialist applications are able to print onto print media such as plastic cards (for making ID cards, credit cards and the like), product packaging, and so on.

Customising printer models can be a difficult process, because designing a new version of a printer can be expensive. A sector of the market may be willing to pay a premium for a double-sided printing capacity, for example, but the remainder of the market may only seek a single-sided printing capacity at a lower cost. In many cases, however, the owners of single-sided printers may eventually wish to upgrade to a double-sided printing capacity, so it is desirable to provide a means to upgrade a single-sided model to a double-sided model. Conventionally this may be done by a dealer-fitted upgrade that involves installing additional hardware or firmware into the printer. This process can represent an inconvenience for the user.

Calibration of printers can also be difficult. A calibration process may be undertaken in the factory to take into account manufacturing tolerances in the relative positions of the print head and sensors associated with the print head, for example, and tolerances in the size and shape of printer rollers (and hence the distance that they move for a given unit of rotation). Conventionally, calibration may involve carrying out a number of test prints onto print media, and making adjustments to calibration constants until the printing covers the appropriate area. This can be a time-consuming and expensive task, however.

Further calibration may be required for example in relation to the intensity of light emitters used in optical sensors for detecting the passage of print media, printer consumable material, and so on.

### SUMMARY OF THE INVENTION

In consideration of the above issues, the present invention provides a printer comprising a print unit for printing on a print medium, a print media reversal unit and a print controller. The print controller is adapted in one embodiment to operate the printer in either a single-sided or double-sided mode in dependence on the printer configuration data, and to update the printer configuration data appropriately in response to receiving an instruction to permit the operation of the printer in a double-sided printing mode. A corresponding method is also provided.

Further apparatuses and methods, including but not limited to embodiments of a card printer and processes for calibrating such a printer, may also be provided. These further apparatuses and methods can have applications beyond the examples mentioned above.

### BRIEF DESCRIPTION OF THE DRAWINGS

Embodiments of the present invention will now be described with reference to the accompanying drawings, in which:

FIG. 1 is an overview of a printer system in accordance with a first embodiment of the present invention;

FIG. 2 is a schematic of the print controller of FIG. 1;

FIG. 3 is an overview of the printer devices of FIG. 1;

FIG. 4 is a schematic of the sensors of FIG. 1;

FIG. 5 is a schematic of the print path of the printer of FIG. 1;

FIG. 6 is a detailed schematic of the printer of FIG. 1 in profile showing the approximate arrangement of parts;

FIG. 7 is a further schematic of the printer of FIG. 1 in profile, with some parts hidden;

FIG. 8 is an illustration of the rotation unit shown in FIG. 5;

FIG. 9 is an illustration of a card printed by the printer of FIG. 1;

FIG. 10 is an illustration of the dye film package of FIG. 1;

FIG. 11 is a further illustration of the dye film package of FIG. 1, showing different dye film panels in the package;

FIG. 12 is a flow diagram illustrating the process of printing a card using the printer of FIG. 1;

FIG. 13 is a flow diagram illustrating in more detail the process in FIG. 12 of loading a card into the rotation unit;

FIG. 14 is a flow diagram illustrating in more detail the process in FIG. 12 of printing onto the card;

FIG. 15 is a flow diagram illustrating in more detail the process in FIG. 14 of depositing dye layers onto the card;

FIG. 16 is a flow diagram illustrating the steps carried out by the print controller of FIG. 1 in response to a new dye film package being loaded;

FIG. 17 is a graph illustrating the intensity of different colours of light passing through different types of dye film panel;

FIG. 18 is a graph illustrating approximately the strength of the transitions in FIG. 17 between the intensities of the different colours of light during the transition from one dye film panel to the next;

FIG. 19 is a flowchart illustrating a process loop carried out by the print controller of FIG. 1 to detect the transition between different dye film panels;

FIG. 20 is a flowchart illustrating a calibration process for determining the LED intensities used in the loop of FIG. 19;

FIG. 21 is a flowchart illustrating in more detail the process in FIG. 20 of taking readings from the dye film sensor photocell;

FIG. 22 is a flowchart illustrating in more detail the process in FIG. 21 of determining the threshold LED intensity for a particular LED colour;

FIG. 23 is a graph illustrating the approximate relationship between the current applied to an LED and the intensity of the LED for a linearly increasing current;

FIG. 24 is a graph illustrating the approximate relationship between the current applied to an LED and the intensity of the LED for a pulse width modulated current having a linearly increasing mark/space ratio;

FIG. 25 is an illustration of the cluster analysis process of FIG. 20;

FIG. 26 is a flowchart illustrating a calibration process for calibrating the printer of FIG. 1;

FIG. 27 is an illustration of a card printed using the process of FIG. 26; and

FIG. 28 is an illustration of the LED output intensity and the photocell output that is used as the card of FIG. 27 is scanned through the print path.

### GENERAL DESCRIPTION

Before the embodiments shown in the attached figures are described in detail, a few general and non-limiting remarks will be made:

In one embodiment there is provided a printer (such as a card printer, paper printer or other type of printer using inkjet, laser or dye sublimation technology, for example), comprising a print unit (including a thermal or inkjet print head, for example) for printing on a print medium (such as a plastic card or other material such as paper, card, and so on); a print media reversal unit (such as a ‘flipper’ or rotation unit) for reversing the print medium to allow double-sided printing onto the print medium; a memory unit (such as a RAM, EPROM, flash memory or permanent storage unit such as a hard disk) for storing printer configuration data, the printer configuration data including data specifying whether or not the printer is permitted to operate in a double-sided printing mode; an input device for receiving an instruction to permit the operation of the printer in a double-sided printing mode; and a print controller (such as a CPU and optionally associated program memory) for controlling the print unit and the print media rotation unit, the controller being programmed to operate the printer in either a single-sided or double-sided mode in dependence on the printer configuration data, and to update the printer configuration data appropriately in response to receiving the instruction to permit the operation of the printer in a double-sided printing mode.

Accordingly, a single-sided printer can be upgraded to a double-sided printer by providing it with the necessary hardware in the first instance and then simply issuing an instruction to alter configuration data.

The printer may further comprise a mount for receiving a printer consumable package (such as a dye sublimation film package, which may be enclosed in a package or may simply comprise dye film wound around two spools), and wherein the input device is operable to receive the instruction from a computer-readable tag in the printer consumable package. The tag may be an RFID chip, smartcard or any other appropriate data encoding technology, and the input device may thus be an RFID transceiver, smartcard reader and so on. Thus the process of upgrading the printer may be as simple as replacing a printer consumable package.

The input device may be operable to receive authentication information (including data encoded using public key cryptography techniques, for example) from the computer-readable tag, and the print controller may be further programmed to process the authentication information and to enable or disable the operation of the printer in conjunction with the printer consumable package in dependence on the processing. This can prevent against a fraudulent attempt to upgrade the printer, for example.

In one embodiment, the print unit includes a first pair of rollers (which in one embodiment may only be a single roller) for gripping the print medium during printing; the print media reversal unit includes a second pair of rollers (which again in one embodiment may only be a single roller) for gripping the print medium while it is being reversed; and the second pair of rollers is arranged additionally to grip the print medium while the print unit is printing on the print media. By re-using the rollers in the print media reversal unit as a second pair of rollers for the print unit, the number of rollers required overall can be reduced, and a more compact and affordable printer can be produced.

This feature may also be provided in independent form. Accordingly, another embodiment provides a printer, comprising a print unit for printing on a print medium, including a first pair of rollers for gripping the print medium during printing; and a print media reversal unit for reversing the print medium to allow double-sided printing onto the print medium, the print media reversal unit including a second pair of rollers for gripping the print medium while it is being reversed, wherein the second pair of rollers is arranged additionally to grip the print medium while the print unit is printing on the print media.

The printer may further comprise a data encoder unit (such as a magnetic stripe encoder) for encoding data into a data carrier (such as a magnetic strip) in the print medium, and wherein the print media reversal unit is operable to feed the print medium into the data encoder unit.

The print unit may be operable to imprint printer consumable material onto a print medium, and the print unit may be arranged such that, in use, the print medium passes through the print unit in a defined print path; and the printer may further comprise: a variable power emitter of electromagnetic radiation (such as a variable power LED or a standard LED controllable using pulse width modulation or other means in order to vary the intensity), the emitter being arranged on a first side of the print path; and a detector of the electromagnetic radiation (such as a photocell), the detector being arranged on a second side of the print path and outputting a detection signal; the print medium has a first opacity to the electromagnetic radiation, and the print medium with the printer consumable material imprinted on it has a second opacity to the electromagnetic radiation; and the print controller is programmed to set the power of the emitter to one of a first power level and a second power level in dependence on the first opacity and second opacity, such that when the emitter is set to the first power level the detector can detect the presence or absence of the print medium, and when the emitter is set to the second power level the detector can detect the presence or absence of the printer consumable material on the print medium. This can allow the detecting both of the presence or absence of the print medium but also the detection of the presence or absence of features printed onto the print medium using a single optical sensor.

This feature is also provided in independent form. Accordingly, in one embodiment there is provided a printer, comprising: a print unit for imprinting printer consumable material onto a print medium, the print unit being arranged such that, in use, the print medium passes through the print unit in a defined print path; a variable power emitter of electromagnetic radiation, the emitter being arranged on a first side of the print path; a detector of the electromagnetic radiation, the detector being arranged on a second side of the print path and outputting a detection signal; and a print controller for controlling the print unit, the variable power emitter and the detector, and receiving the detection signal, wherein the print medium has a first opacity to the electromagnetic radiation, and the print medium with the printer consumable material imprinted on it has a second opacity to the electromagnetic radiation, and the print controller is programmed to set the power of the emitter to one of a first power level and a second power level in dependence on the first opacity and second opacity, such that when the emitter is set to the first power level the detector can detect the presence or absence of the print medium, and when the emitter is set to the second power level the detector can detect the presence or absence of the printer consumable material on the print medium.

The printer may further comprise a print media transport unit (such as one or more rollers, which may be for example the print rollers mentioned above) for transporting the print medium along the print path, the print media transport unit being controllable by the print controller to transport the print medium by a number of steps specified by the print controller, and each step corresponding to a distance along the print path. The print media transport unit may include one or more stepper motors, for example.

The printer controller may be further programmed to: set the power of the emitter to the first power level; control the print media transport unit to transport a print medium of a defined length through the print path; process the detection signal to identify transitions in the detection signal corresponding to edges of the print medium passing between the emitter and the detector, and to identify the number of steps carried out by the print media transport unit between the transitions; and process the identified transitions and identified number of steps to calculate the distance moved by the print medium per step carried out by the print media transport unit. The print controller may reside only in part or not at all in the printer itself. For example, the print controller may include a calibration computer operated by a technician. The calibration function may be operated in the factory, for example, or may be carried out in-situ or on-the-fly.

If the printer is used with a print medium of a defined first length having the printer consumable material imprinted on a first print area and a second print area, the first and second print areas being separated by a second length, the print controller may be further programmed to: set the power of the emitter to the second power level; control the print media transport unit to transport the print medium through the print path; process the detection signal to identify transitions in the detection signal corresponding to the first and second print areas of the print medium passing between the emitter and the detector, and to identify the number of steps carried out by the print media transport unit between the transitions; and process the identified transitions and identified number of steps to calculate the distance moved by the print medium per step carried out by the print media transport unit.

The print unit may include a print head, and the print controller may be further programmed to control the print unit and the print media transport unit to imprint the first and second print areas on the print medium, and to process the identified transitions to calculate a value related to a distance along the print path between the print head and the emitter and detector. The print controller may be further programmed to process the identified transitions to determine the distance between the first print area and the edge of the print medium. The print controller may be further programmed to calculate calibration constants relating to the print unit, and store the calibration constants.

The printer may further comprise a manual print feed unit, arranged in conjunction with the print media reversal unit to allow a user to feed a print medium into the second pair of rollers.

This feature is also provided in independent form. Accordingly in one embodiment there is provided a printer, comprising: a print unit for printing on a print medium; a print media reversal unit for reversing the print medium to allow double-sided printing onto the print medium, the print media reversal unit including at least one pair of rollers for gripping the print medium while it is being reversed, and a manual print feed unit, arranged in conjunction with the print media reversal unit to allow a user to feed a print medium into a said pair of rollers.

The print media reversal unit may be rotatable around a pivot, and may have a substantially convex profile (such as a substantially circular or oval profile) in the plane of the pivot except for at least one opening for receiving the manually fed print medium. This can help to prevent misfeeds by the print medium getting ‘snagged’ on the print media reversal unit when it is not positioned to receive the print medium.

The manual print feed unit may include a selectively releasable shutter for preventing insertion of the print medium by the user, the shutter being releasable when the print media reversal unit is in a predetermined orientation relative to the manual print feed unit. This can help to prevent jamming if the print media reversal unit is not in a suitable orientation to receive the print medium.

If the printer is used with a printer consumable material (such as dye sublimation film) including a substantially transparent substrate and a plurality of regions of printable material embedded on the substrate, each of the regions being coloured a particular colour, the print unit may be arranged such that, in use, the substrate passes through the print unit in a defined printer consumable feed path; the printer further comprises: a multi wavelength emitter (such as a multi-colour LED) for selectively emitting a plurality of wavelengths of electromagnetic radiation (such as visible light or infrared light, for example), the multi wavelength emitter being arranged on a first side of the printer consumable feed path; and a multi wavelength detector (such as a photocell, for example) for detecting the emitted electromagnetic radiation, the multi wavelength detector being arranged on a second side of the printer consumable feed path and outputting a detection signal; the print controller is programmed to: select a wavelength from the plurality of wavelengths of electromagnetic radiation; control the multi wavelength emitter to emit the selected wavelength; and process the multi wavelength detection signal to calculate the colour of the region between the multi wavelength emitter and the multi wavelength detector. In this context, the multi wavelength emitter denotes an emitter of capable of emitting more than one wavelength of electromagnetic radiation (not necessarily at the same time). The multi wavelength detector should be understood as merely being able to detect more than one wavelength of light (again, not necessarily at the same time or to be able to distinguish between different wavelengths).

This feature is also provided independently. Accordingly another embodiment provides a printer for use with a printer consumable material, the printer consumable material including a substantially transparent substrate and a plurality of regions of printable material embedded on the substrate, each of the regions being coloured a particular colour, and the printer comprising: a print unit for imprinting the printable material onto a print medium, the print unit being arranged such that, in use, the substrate passes through the print unit in a defined printer consumable feed path; a multi wavelength emitter for selectively emitting a plurality of wavelengths of electromagnetic radiation, the multi wavelength emitter being arranged on a first side of the printer consumable feed path; a multi wavelength detector for detecting the emitted electromagnetic radiation, the multi wavelength detector being arranged on a second side of the printer consumable feed path and outputting a detection signal; and a print controller for controlling the print unit, the multi wavelength emitter and the multi wavelength detector, and receiving the detection signal, wherein the print controller is programmed to: select a wavelength from the plurality of wavelengths of electromagnetic radiation; control the multi wavelength emitter to emit the selected wavelength; and process the detection signal to calculate the colour of the region between the multi wavelength emitter and the multi wavelength detector. The regions may for example be coloured panes in a roll of dye-sublimation film. The colours may for example include an overlay or clear layer (substantially transparent), cyan, magenta, yellow or key (black). Thus the term ‘colour’ may define a degree of transparency (distinguishing, for example, between black and transparent regions) as well as a dominant wavelength of light that is reflected or absorbed (distinguishing, for example, between cyan, magenta and yellow regions). Other wavelengths of electromagnetic radiation (such as infrared or ultraviolet light) may also be used where appropriate.

If the printer uses a printer consumable medium in which the regions are arranged on the substrate in a defined sequence, the print controller may be programmed to: monitor the current position in the sequence; and select the wavelength in dependence on the colour of the next region expected in the sequence. For example, some wavelengths of light can distinguish between two adjacent panels, but a different wavelength of light may be needed to distinguish between the second panel and a subsequent panel.

The print controller may be further programmed to repeatedly cycle the selected wavelength and to process the detection signal to estimate a plurality of colour parameters relating to the region between the multi wavelength emitter and the multi wavelength detector. The print controller may for example create an estimate of the (R, G, B), (C, M, Y) or (C, M, Y, K) components of the colour of the current region by determining the light absorption properties of the substrate in respect of a plurality of colours within the relevant colour space. The cycling is preferably rapid with respect to the transition speed of the regions of the substrate. For example, preferably a plurality of cycles (more preferably more than 5, 10 or 20 cycles, say) may be expected to be carried out between region transitions.

The detection signal may encode a detection amplitude, and the print controller may be further programmed to compare the detection amplitude with a detection threshold to determine the transition between one region and the next. The detection amplitude may for example be an analogue signal that is converted using an analogue-to-digital converter for processing by the print controller (as opposed to a digital (binary) on-off value, for example).

The print controller may be further programmed to change the detection threshold in dependence on the detection amplitude. Thus, in simple terms, the printer may be able to dynamically recalibrate the colour detection using the analogue signal produced by the emitter.

Another embodiment provides a printer for use with a printer consumable material, the printer consumable material including a substantially transparent substrate and a plurality of regions of printable material embedded on the substrate, each of the regions being coloured a particular colour, and the printer comprising: a print unit for imprinting the printable material onto a print medium, the print unit being arranged such that, in use, the substrate passes through the print unit in a defined printer consumable feed path; an emitter for selectively emitting a plurality of wavelengths of electromagnetic radiation, the emitter being arranged on a first side of the printer consumable feed path; a detector for detecting the emitted electromagnetic radiation, the detector being arranged on a second side of the printer consumable feed path and outputting a detection signal; and a print controller for controlling the print unit, the emitter and the detector, and receiving the detection signal, wherein the print controller is programmed to carry out a calibration sequence including the steps of: iterating for a number of times through the steps of: selecting a wavelength from the plurality of wavelengths of electromagnetic radiation, the selected wavelength being selected in a cyclic fashion; controlling the emitter to emit the selected wavelength; storing the detection signal received from the detector; and advancing the substrate of the printer consumable material; and processing the stored detection signals to calculate at least one detection threshold for detecting transitions between the different regions of the substrate.

Thus the print controller first takes a plurality of samples from the detector as the substrate is wound through a potentially large number of regions, and then analyses the samples to set appropriate detection thresholds. The print controller may, as before, include a calibration unit that may or may not be provided within the printer housing. It may, for example, include a workstation in a factory manufacturing the printers. The print controller may be further programmed to process the stored detection signals using a statistical cluster analysis. Preferably the thresholds are chosen such that all of the observed clusters are clearly separated by the thresholds.

The print controller may also be operable in a printing mode in which it is programmed to: select a wavelength from the plurality of wavelengths of electromagnetic radiation; control the emitter to emit the selected wavelength; and process the detection signal in dependence on said at least one detection threshold to calculate the colour of the region between the emitter and the detector. The detection signal may encode a detection amplitude, and the print controller may be further programmed to compare the detection amplitude with a said detection threshold to determine the transition between one region and the next. The print controller may be programmed to restart the calibration sequence in response to a predefined event. The event may be, for example, the replacement of the printer consumable material, or a timer or counter indicating that a predetermined number of print cycles or periods of time have elapsed, an error signal relating, for example, to the detector or emitter, or a user input. The calibration may therefore take place during or after the ‘normal’ operation of the printer, and may thus be carried out in-situ.

Another embodiment provides a printer consumable package, comprising: printer consumable material; and a computer-readable tag, the computer-readable tag encoding instruction data to instruct the printer to permit printing in a double-sided mode. The computer-readable tag may also encode authentication information.

The above-mentioned embodiments may also include methods equivalent to the apparatus features discussed above.

For example, one embodiment provides a method of operating a printer, the printer comprising a print unit for printing on a print medium, a print media reversal unit for reversing the print medium to allow double-sided printing onto the print medium, a memory unit for storing printer configuration data, the printer configuration data including data specifying whether or not the printer is permitted to operate in a double-sided printing mode, an input device for receiving an instruction to permit the operation of the printer in a double-sided printing mode, and a print controller for controlling the print unit and the print media rotation unit, and the method comprising: operating the printer in either a single-sided or double-sided mode in dependence on the printer configuration data; and updating the printer configuration data appropriately in response to receiving the instruction to permit the operation of the printer in a double-sided printing mode.

Further methods are provided as mentioned above, based on various combinations of apparatus features disclosed herein.

Another embodiment provides a computer comprising: an instruction memory storing processor implementable instructions; and a processor operable to process data in accordance with instructions stored in the instruction memory; wherein the instructions stored in the instruction memory comprise instructions for controlling the processor to perform a method as aforesasid.

A further embodiment provides a printer, comprising: means for printing on a print medium; means for reversing the print medium to allow double-sided printing onto the print medium; means for storing printer configuration data, the printer configuration data including data specifying whether or not the printer is permitted to operate in a double-sided printing mode; means for receiving an instruction to permit the operation of the printer in a double-sided printing mode; and means for controlling the print unit and the print media rotation unit, the means for controlling being programmed to operate the printer in either a single-sided or double-sided mode in dependence on the printer configuration data, and to update the printer configuration data appropriately in response to receiving the instruction to permit the operation of the printer in a double-sided printing mode.

Another embodiment provides a printer, comprising means for printing on a print medium, including a first means for gripping the print medium during printing; and means for reversing the print medium to allow double-sided printing onto the print medium, the means for reversing including a second means for gripping the print medium while it is being reversed, wherein the second means for gripping is arranged additionally to grip the print medium while the means for printing is operating.

A further embodiment provides a printer, comprising: means for imprinting printer consumable material onto a print medium, the means for printing being arranged such that, in use, the print medium passes through the means for printing in a defined print path; means for emitting electromagnetic radiation, arranged on a first side of the print path; means for detecting electromagnetic radiation, arranged on a second side of the print path and outputting a detection signal; and means for controlling the printer, wherein the print medium has a first opacity to the electromagnetic radiation, and the print medium with the printer consumable material imprinted on it has a second opacity to the electromagnetic radiation, and the means for controlling is adapted to set the power of the means for emitting to one of a first power level and a second power level in dependence on the first opacity and second opacity, such that when the means for emitting is set to the first power level the means for detecting can detect the presence or absence of the print medium, and when the means for emitting is set to the second power level the means for detecting can detect the presence or absence of the printer consumable material on the print medium.

A yet further embodiment provides a printer, comprising: means for printing on a print medium; means for reversing the print medium to allow double-sided printing onto the print medium, the means for reversing including means for gripping the print medium while it is being reversed, and means for manually feeding a print medium into the means for gripping the print medium, to allow a user to feed a print medium into the means for reversing.

Another embodiment provides a printer for use with a printer consumable material, the printer consumable material including a substantially transparent substrate and a plurality of regions of printable material embedded on the substrate, each of the regions being coloured a particular colour, and the printer comprising: means for imprinting the printable material onto a print medium, the means for printing being arranged such that, in use, the substrate passes through the means for printing in a defined printer consumable feed path; means for selectively emitting a plurality of wavelengths of electromagnetic radiation, the means for selectively emitting being arranged on a first side of the printer consumable feed path; means for detecting the plurality of wavelengths of electromagnetic radiation, the means for detecting being arranged on a second side of the printer consumable feed path and outputting a detection signal; and means for controlling the means for printing, the means for selectively emitting and the means for detecting the plurality of wavelengths, and for receiving the detection signal, wherein the means for controlling is adapted to: select a wavelength from the plurality of wavelengths of electromagnetic radiation; control the means for selectively emitting to emit the selected wavelength; and process the detection signal to calculate the colour of the region between the means for selectively emitting and the means for detecting a plurality of wavelengths.

Another embodiment provides a printer for use with a printer consumable material, the printer consumable material including a substantially transparent substrate and a plurality of regions of printable material embedded on the substrate, each of the regions being coloured a particular colour, and the printer comprising: means for imprinting the printable material onto a print medium, the means for printing being arranged such that, in use, the substrate passes through the print unit in a defined printer consumable feed path; means for selectively emitting a plurality of wavelengths of electromagnetic radiation, the means for selectively emitting being arranged on a first side of the printer consumable feed path; means for detecting the plurality of wavelengths of emitted electromagnetic radiation, the means for detecting being arranged on a second side of the printer consumable feed path and outputting a detection signal; and means for controlling the means for printing, the means for selectively emitting and the means for detecting a plurality of wavelengths, and for receiving the detection signal, wherein the means for controlling is adapted to carry out a calibration sequence including the steps of: iterating for a number of times through the steps of: selecting a wavelength from the plurality of wavelengths of electromagnetic radiation, the selected wavelength being selected in a cyclic fashion; controlling the means for selectively emitting to emit the selected wavelength; storing the detection signal received from the means for detecting a plurality of wavelengths; and advancing the substrate of the printer consumable material; and processing the stored detection signals to calculate at least one detection threshold for detecting transitions between the different regions of the substrate.

A further embodiment provides a printer comprising: means for printing onto a print medium; an instruction memory storing processor implementable instructions; and a processor operable to process data in accordance with instructions stored in the instruction memory; wherein the instructions stored in the instruction memory comprise instructions for controlling the processor to perform a method as aforesaid.

The embodiments described herein can be implemented in any convenient form, for example using dedicated hardware, or a mixture of dedicated hardware and software.

The present invention is particularly suited to implementation (in part) as computer software implemented by a dedicated microcontroller (in a printer) and/or a computer workstation (for calibration purposes, for example). The embodiments may further comprise a network, which can include any local area network or even wide area, conventional terrestrial or wireless communications network. The systems may comprise any suitably programmable apparatus such as a general-purpose computer, personal digital assistant, mobile telephone (such as a WAP or 3G-compliant phone) and so on. Aspects of the various embodiments encompass computer software implementable on a programmable device, for example as a hand-held calibration tool. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid-state memory device.

Although each aspect and various features of the various embodiments have been defined independently herein, it will be appreciated that, where appropriate, each aspect can be used in any combination with any other aspect(s) or features.

### DETAILED DESCRIPTION

Various of the embodiments mentioned above will be described in further detail with reference to the attached figures.

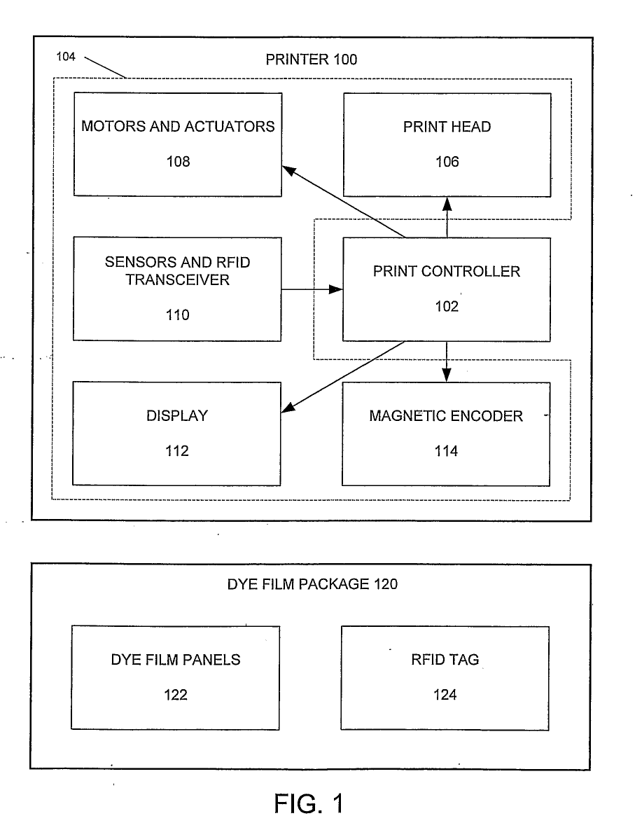

FIG. 1 is an overview of a dye-sublimation card printer in accordance with a first embodiment of the present invention.

The printer 100 includes a print controller 102 and a number of printer components 104, including a thermal print head 106, a number of motors and actuators 108, a number of sensors and an RFID transceiver 110, a display 112 and a magnetic encoder 114. A dye film package 120 is associated with the printer, and includes a large number of dye film panels 122 rolled onto two spools, and an RFID tag 124 containing information relevant to the dye film package 120.

The printer controller 102 controls the printer components 104 to cause the thermal print head 106 to print onto a card (not shown) by sublimating dye from the dye film panels. In use, the dye film panels are moved in a defined direction across the print head. Where elements of the print head heat up, dye is sublimated onto the card. Similar principles are used to those used in paper-based dye sublimation printers, and it will be appreciated that various features of known paper-based dye sublimation printers (and, where appropriate, inkjet and laser printers) can be incorporated into the present embodiment.

The printer is designed primarily to print onto CR79 size plastic cards for the purpose of generating ID cards, but it will be appreciated that other print media may be used as appropriate and for any other purpose.

Various components of the printer will now be described in more detail, followed by a description of the operation of the printer (in particular the process steps carried out by the print controller), and a description of a process for calibrating the printer.

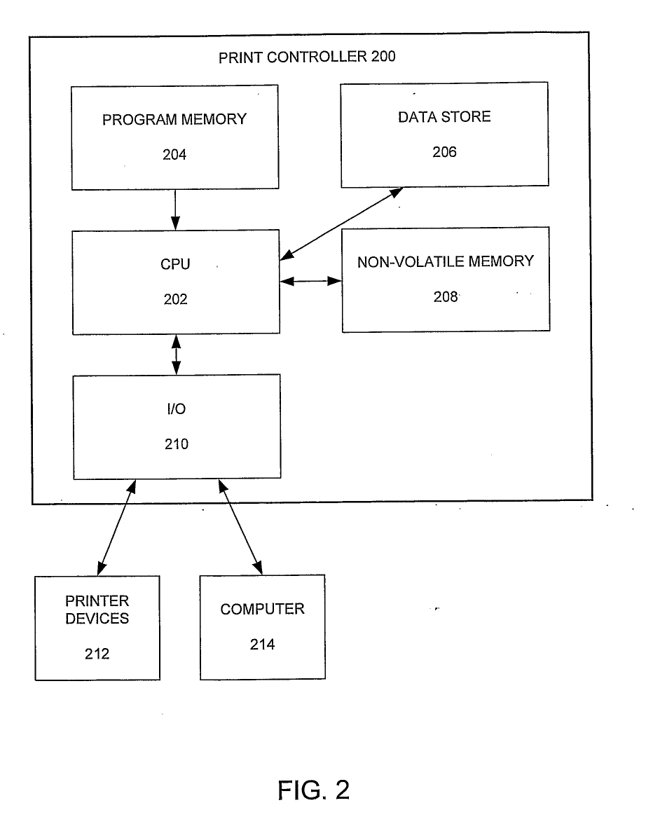

FIG. 2 is a schematic of the print controller of FIG. 1, showing the controller in more detail.

The print controller 200 includes a central processing unit (CPU, 202), a program memory 204 for storing executable computer code, a data store 206 for storing (volatile, temporary) data that is stored and read by the CPU when executing the computer code, a non-volatile memory 208 for storing long-term data such as configuration data and user preferences, and an input/output interface (IO, 210) for communicating with the printer devices 212 and external devices 214 such as a client computer (providing the images for printing) or an external workstation (for calibrating the printer).

The CPU 202 is a conventional CPU embedded in a custom motherboard design, but in a variant of the present embodiment a conventional computer (which may be external to the printer housing) is adapted to control the print functions. In another variant, a self-contained microcontroller is provided that contains all of the CPU and data storage functions in a single physical package.

The data stores 204, 206, 208 may be separate memories, or may be contained in the same memory package. The program memory 204 and non-volatile memory 208 may for example include random access memory (RAM), flash RAM, or any other memory store components of appropriate type, for example, to allow the program code to be updated if necessary (via automatic upgrade routines executed by the CPU, or manually, for example). The program data and non-volatile data may additionally or alternatively be stored in a hard disk or similar mass storage unit contained within the printer or otherwise. The program memory 204 may alternatively be a read only memory (ROM) of an appropriate type. Other variants are of course possible.

The data store 206 is also used as a buffer to hold image data (for printing). The image data may be provided directly by a device attached to the printer, or rendered by the printer controller in dependence on source data provided by such a device, for example.

The input/output interface 210 may include custom circuitry (such as an ASIC) and/or conventional input/output circuitry. It may include serial and/or parallel bus controllers including (but not limited to) I²C controllers, USB controllers, ethernet or other network adaptors, and the like.

The printer devices 212 will now be described in more detail.

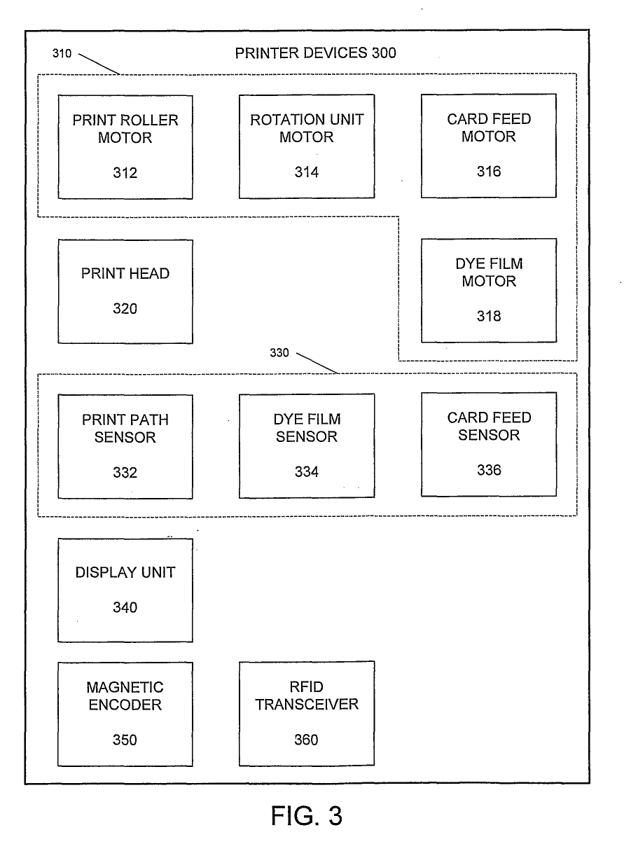

FIG. 3 is an overview of the printer devices of FIG. 1.

The printer devices 300 include a number of motors and actuators 310, including a print roller motor 312 for driving the rollers that move cards along the main print path (see below), a rotation unit motor 314 for rotating the rotation unit (see below), a card feed motor 316 for driving cards into the print path from the card hopper (again, see below), and a dye film motor 318 for driving the dye film past the print head 320. The printer devices 300 also include a number of sensors 330, including an optical print path sensor 332 for detecting the presence of a card in the main print path, an optical dye film sensor 334 for detecting the transition between different panels of the dye film as the dye film is wound past the print head, and an optical card feed sensor 336 for detecting when a card has been acquired by the card hopper/media preventer mechanism. The printer devices 300 also include a display unit 340 for displaying status information and instructions to the user, a magnetic encoder 350 for encoding information in the bar code of a card (if present), and an RFID transceiver 360 for reading the RFID tags embedded in the dye film package.

In the present embodiment, the motors 310 are stepper motors, allowing for accurate control and positioning of the card, rotation unit and dye film. Additional motors of the same or different type may be provided where necessary or appropriate. Also, any number of physical actuators may be provided under the control of the printer controller. In a variant of the present embodiment, for example, a computer-controlled catch is provided in the manual feed slot (see below) to prevent the user feeding in a card manually when the rotation unit is not in the correct position.

The print head 320 is a thermal print head. In the present embodiment, a standard Kyocera thermal print head is used, having 672 independently controllable heating elements. The thermal print head has a bullet profile, which was found to be appropriate for printing onto hard surfaces such as ID cards and the like. However, it will be appreciated that other makes and designs of print heads can be used if appropriate.

As will be explained in more detail below, the sensors 330 are optical, including an LED and a corresponding photocell to detect light emitted by the LED. Other designs of sensors are of course possible, including mechanically operated sensors, magnetically-driven sensors, or sensors using non-visible wavelengths of light such as ultraviolet (UV) or infrared (IR).

The display unit 340 is a standard LCD dot matrix display and includes a controller for converting input text into the appropriate configuration of dots. It will be appreciated that other display technology can be used as appropriate, including LED displays, OLED displays, and so on, and that different control signals may be provided by the printer controller.

The magnetic encoder 350 is another standard component for imprinting information onto a magnetic bar code embedded in a card that is to be printed. The information is imprinted by feeding the card past a write emit, and the information is then read by a corresponding read unit to ensure that the data has been written correctly. In some cases the imprinting of information fails, and the card must be rejected. Thus the magnetic encoder 350 receives instructions from the print controller for encoding onto a card, but can also report back an encoding error.

In a variant of the preferred embodiment, the magnetic encoder 350 is supplemented by a smartcard encoder, for encoding information onto a smartcard embedded in the card using an analogous process. In a further embodiment, the smartcard encoder replaces the magnetic encoder entirely. It will be appreciated that other technologies for embedding information within the card (or within an encoding system embedded in the card) can of course be provided where appropriate.

The RFID transceiver 360 is located next to the housing for receiving one of the dye film spools. When a dye film package is inserted, the RFID transceiver (under the control of the printer controller) communicates with the RFID tag in the dye film package and reads the contents of the tag. In a variant of the present embodiment, the RFID transceiver and RFID tag are replaced by a smartcard reader and smartcard chip respectively. Other technologies can be used as appropriate, including barcode scanners, flash memory, microcontrollers embedded in the dye film package, and so on. However, information storage and transmittal means that can be authenticated and/or encrypted may be desirable.

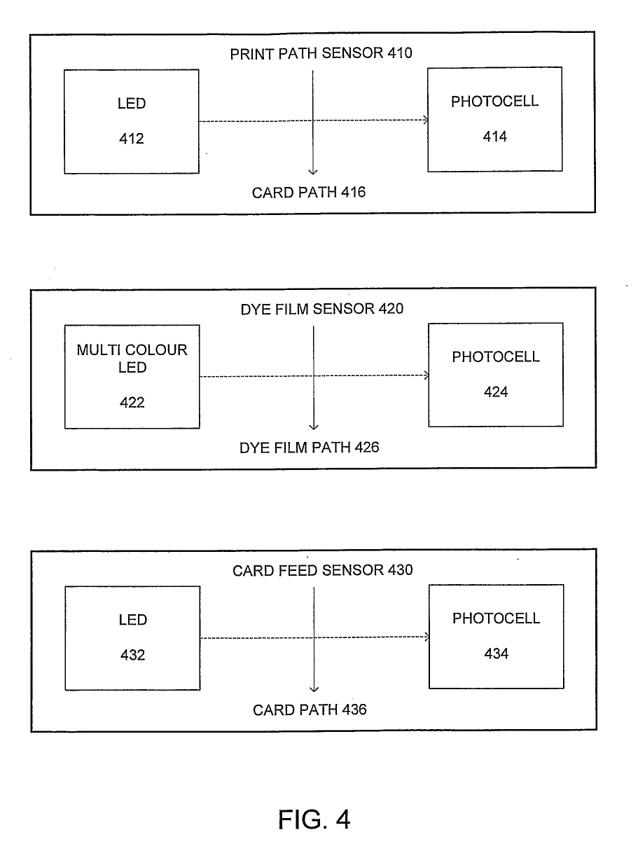

FIG. 4 is a schematic of the sensors of FIG. 1.

As mentioned above, the print path sensor 410 includes a light emitting diode (LED) 412 and a photocell 414 arranged in a line-of-sight configuration on either side of the path 416 that is traversed by a card during printing.

In the present embodiment, the photocell 414 is a standard analogue photocell, but is configured with appropriate circuitry to transmit a binary output signal to the print controller (to simplify the intervening circuitry). The print controller monitors the output signal for transitions, which indicate that a card edge is passing the sensor (from which the position of the card can be determined). The output signal is generated by comparing the output level of the photocell with a predefined threshold value. The threshold may be set manually (via a pot on the circuit board, for example) or under the control of the printer controller or other entity. The threshold value may be configured during a calibration process.

As is explained in more detail below, the output level of the LED 412 is controlled by pulse width modulation under the control of the printer controller, thus avoiding the need for circuitry to vary the current applied to the LED. However, other control means may be provided as appropriate, and a custom variable power LED may be used, for example. The variation of power in the LED is used for the purpose of calibration, and is also explained in more detail below.

In variants of the present embodiment, additional print path sensors are provided to provide greater accuracy in tracking the progress of cards through the print path.

The dye film sensor 420 includes a multi-colour LED 422 and another photocell 424 arranged in a line-of-sight configuration on either side of the path 426 followed by the dye film between the two dye film spools and around the print head.

In the present embodiment, the dye film photocell 424 is configured in the same way as the photocell 414, but the LED 422 differs from the LED 412 in that it can output red, green or blue wavelengths of light (or any combination of the three), under the control of the print controller. The intensity of the light emitted by the LED 422 is also controlled by the print controller, and again using pulse-width modulation rather than more expensive variable current circuitry. However, as before, any number of different arrangements are possible (such as three separate red, green and blue LEDs, for example, or a light source other than an LED, such as an OLED, LCD or other source) provided that independently variable amounts of different wavelengths of light can be emitted. The use of the multi-colour LED is described in more detail below.

The card feed sensor 430 includes an LED 432 and a photocell 434 again arranged in a line-of-sight configuration on either sides of the path 436 traveled by cards as they are engaged by the card hopper/media preventer mechanism. Similar remarks apply (where appropriate) to the LED 432 as apply to the LEDs 412, 422 (and likewise for the photocells 414, 424, 434), although the LED 432 is not normally required to vary in power output or output colour.

It will be appreciated that additional sensors may be provided in order to increase the accuracy of information available to the printer controller about the location of one or more cards within the printer. Additional sensors may be provided, for example, in the rotation unit, print path, manual feed (see below) and/or magnetic encoder.

Also, further sensors may be provided to provide information about other aspects of the printer. For example, a sensor may be provided to determine whether or not the printer cover is closed. Any appropriate scheme may be used (such as multiplexing, address mapping and/or analogue-to-digital conversion) to make the sensor outputs available to the printer controller (via the input/output component).

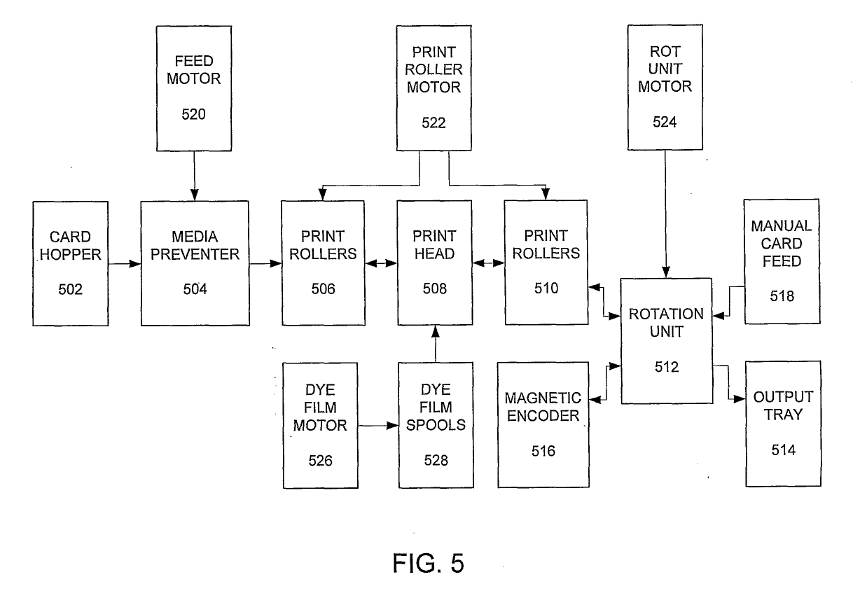

FIG. 5 is a schematic of the print path of the printer of FIG. 1, showing the interrelationship of various components of the printer.

During the automatic card feed mode, cards are supplied in the card hopper 502 located at the rear of the printer. The card hopper 502 has a capacity of approximately 100 cards (blank CR79 cards are typically available in packs of 100).

A media preventer/card hopper feeder 504 allows the passage of a single card from the card hopper 502 into the main print path (when energised). The media preventer 504 is designed so as to prevent more than one card being fed at any one time.

Cards are then transported by the print rollers 506 past the thermal print head 508, and are picked up by a second pair of print rollers 510 on the other side of the print head. The rotation unit 512 (also known as a media reversal unit or ‘flipper’), when rotated to the correct angle, receives the card as it leaves the print path. After a print cycle is completed, the rotation unit then rotates and feeds the card out into the output tray 514 at the front of the printer. A user can then pick up the finished article.

The rotation unit has a tachometer associated with it to assist the printer controller to set the rotation unit to the correct rotation. (Tachometers may also be provided in relation to the dye film spools (see below) and other geared parts in order to assist with tracking.)

If magnetic encoding is required, when the card is first fed in from the hopper 502 it is passed through the main print path into the rotation unit 512 without any printing taking place, and is then fed into the magnetic encoder 516 for encoding. This step takes place first because of the possibility that the magnetic strip on a card may have failed (thus saving printer consumable costs if it has). The card is then fed back into the print path by the rotation unit 512. If no magnetic encoding is required, this step in omitted. In a variant of the present embodiment, the magnetic encoding is carried out after printing, rather than before. The user can also override the default setting.

The manual card feed 518 provides an alternative means of feeding in a card for printing. The card feed 518 comprises a slot at the front of the printer that feeds straight into the card rotation unit 512. The rotation unit 512 can then feed the card straight into the magnetic encoder (if appropriate) or else into the main print path for printing.

The feed motor 520 drives the media preventer/card hopper feeder 504. The print roller motor 522 drives the two printer rollers 506, 510. The rotation unit motor 524 causes the rotation unit to rotate when energised. The dye film motor 526 causes the dye film spools 528 to rotate, causing dye film to be fed from one spool to another past the print head 506. Other motors may be provided, as noted above.

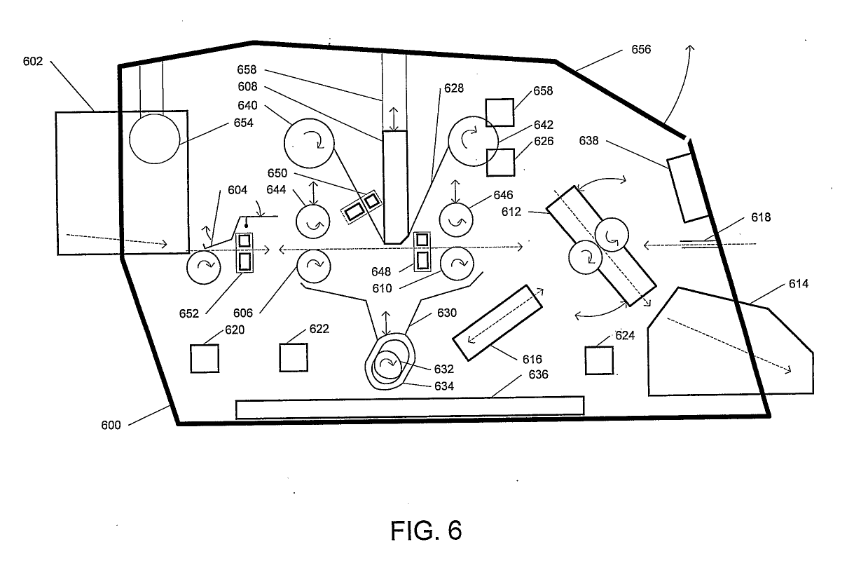

FIG. 6 is a detailed schematic of the printer of FIG. 1 in profile showing the approximate arrangement of parts. The components of FIG. 5 are numbered similarly in FIG. 6.

As before, the printer 600 includes a card hopper 602, a media preventer/card hopper feeder 604, a first print roller 606, a thermal print head 608, a second print roller 610, a rotation unit 612, an output tray 614, a magnetic encoder 616, a manual card feed 618, a hopper feed motor 620 for driving the card hopper feeder 604, a print roller motor 622 for driving the two rollers 606, 610, a rotation unit motor 624 for rotating the rotation unit 612, and a dye film motor 626 for driving the dye film 628 past the print head 606.

The printer 600 also includes a mechanical linkage 630 for independently positioning the print head 606 and related components. A cam 632 drives a cam follower 634 to cause the linkage 630 to move in the desired fashion (see below). A separate motor (not shown) is provided to drive the cam 632 under the control of the printer controller.

The print controller and associated circuitry are provided on the motherboard 636. Additional components of the circuitry are distributed where necessary throughout the printer chassis 600. The display unit 638 is also shown.

The printer 600 also includes the housings 640, 642 for the dye film. Also shown are idler rollers 644, 646. The idler rollers 644, 646 are attached to the mechanical linkage 630. The linkage 630 is connected to the print head 606 and idler rollers 644, 646 such that when the print head 606 is lowered onto the print path for a print cycle, the idler rollers 644, 646 are withdrawn. This is to avoid marking the printed surface and to reduce the possibility of damaging the magnetic strip on the card.

The print path sensor 648, the dye film sensor 650 and the card feeder sensor 652 are shown. In the present embodiment, the print path sensor is mounted on the print head 606 itself, but in variants it may be located elsewhere.

A hinge 654 allows the upper portion 656 of the printer chassis 600 to be opened to allow the dye film package to be changed. The print head 606 is attached to the upper portion 656 to lift it clear when the chassis is opened, in order to facilitate this operation.

In a variant of the present embodiment, the rotation unit 612 is shaped with a continuous convex surface (apart from the slots for feeding in the card) in order to reduce the chance of the printer jamming if the user attempts to feed in a card while the rotation unit is not aligned with the manual feed slot. The rotation unit may have an essentially circular profile, for example, or a more complex but nonetheless convex profile. In another variant, a catch is provided to physically prevent the user insert the card at the wrong moment. The catch may be physically operated by a protrusion from the rotation unit, for example.

The media preventer 604 includes an elongate portion with an angled surface that abuts the bottom card in the card hopper. The elongate portion is biased around a pivot to urge the angled surface down onto a feed roller. When the elongate portion is in the ‘unloaded’ position (with no card inserted) the angled surface is angled so that it urges a card onto the feed roller. When the feed roller is energised, a card is urged under the angled surface, rotating the elongate portion away from the feed roller so as to change the angle of the angled surface, whereby the surface no longer urges cards against the feed roller but instead blocks the passage of any further cards. As the current card is taken up by the first print roller, the feed sensor detects the presence of the card, and causes the feed motor to cease. This mechanism is illustrated schematically in FIG. 6.

A tachometer wheel (not shown) is attached to one of the dye film spool housings. Small regular holes in the wheel allow an optical sensor to track the position and speed of the spool as it rotates.

Various connectors (not shown) are also provided, to allow external devices to connect to the printer. The images to be printed and various control signals can be sent via these connectors.

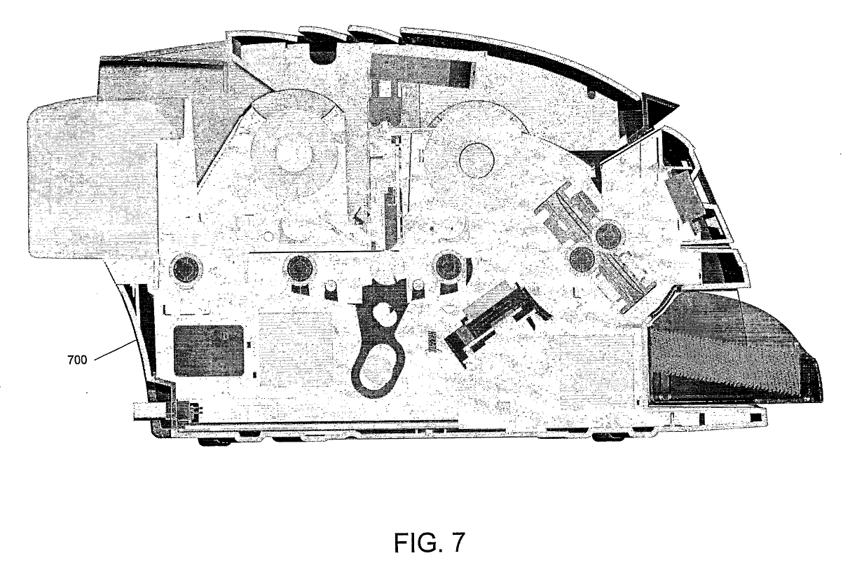

FIG. 7 is a further schematic of the printer 700 of FIG. 1 in profile, with some parts hidden.

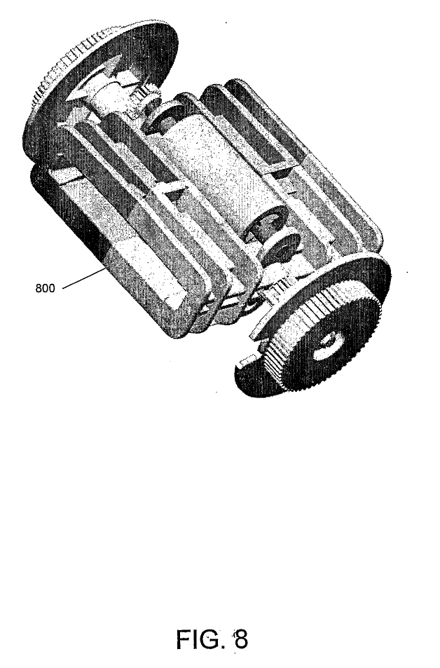

FIG. 8 is an illustration of the rotation unit 800 shown in FIG. 5. It can be observed that various gearings are provided to ensure that a card remains stationary relative to the rotation unit when it is being rotated.

It will also be observed that one of the gears has a notch. An optical sensor adjacent to the gear detects the presence or absence of the notch and thus provides a tachometer reading indicating the number of complete rotations undertaken by the rotation unit 800. Similar principles can be applied elsewhere. Other similar schemes are possible, for example, including varying the optical appearance of the gear (without making a notch), for example by applying reflective paint.

The print media (cards) and printer consumables (dye film package) will now be described in more detail.

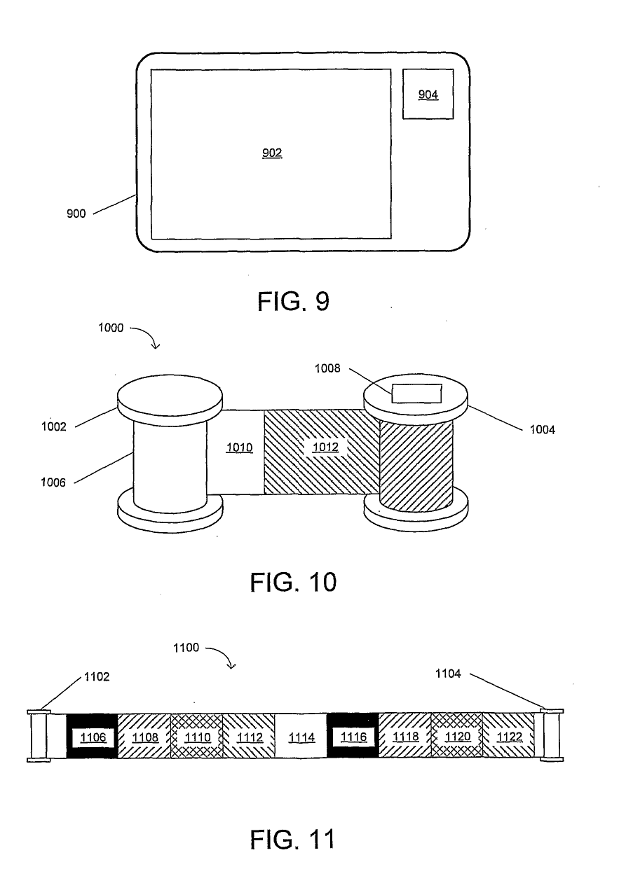

FIG. 9 is an illustration of a card printed by the printer of FIG. 1.

The card 900 includes a printed area 902 and an optional embossed metallic region 904 that can be produced by a variant of the present embodiment. The reverse of the card (not shown) may include a conventional (or other) magnetic stripe for encoding by the magnetic encoder. The printed area 902 can extend across the entire surface of the card if desired, and is formed by the deposition of multiple layers of dye, as will now be described with reference to FIGS. 10 to 15.

FIG. 10 is an illustration of the dye film package of FIG. 1.

The dye film package 1000 includes a first spool 1002 and a second spool 1004, and a roll 1006 of dye film wrapped around the two spools. One of the spools is a supply spool and the other is a take-up spool. An RFID tag 1008 is embedded in one of the spools. The roll of film 1006 includes a number of adjacent panels 1010, 1012 of different colour dye film. The spools 1002, 1004 may also include additional features (mechanical or otherwise, not shown) to assist with their installation in the printer.

The package 1000 may be wrapped in a protective coating prior to use, and in variants of the present embodiment the spools are enclosed in a casing that is mounted directly in the printer (for faster reloading). Other appropriate arrangements of the dye film and dye film panels are of course possible.

FIG. 11 is a further illustration of the dye film package of FIG. 1, showing different dye film panels in the package.

The dye film package 1100 includes the two spools 1102, 1104 as before. Also shown is the sequence 1106, 1108, 1110, 1112, 1114 of black (key), cyan, magenta, yellow and clear (overcoat) dye film panels respectively. The sequence of panels 1106, 1108, 1110, 1112, 1114 repeats as panels 1116, 1118, 1120, 1122 and so on.

Every time a card is printed, the dye film is advanced by a complete set of panels 1106, 1108, 1110, 1112, 1114, with each pass of the print head (or rather, each pass of the card past the print head) selectively depositing portions of one of the panels.

In the present embodiment, a panel is used only once for printing (because portions of it and potentially the whole of it will be depleted). The take-up spool winds on until all of the film from the supply spool is used up, and then the dye film package is effectively spent. The printer controller monitors the amount of dye film that has been used, and provides a warning to the user when the amount of dye film remaining is low and when the dye film has run out.

The black, cyan, magenta and yellow panels collectively allow a large gamut of colours to be printed using various combinations of the four colours (here the term ‘colour’ is used broadly, including items both with a black appearance and a clear or transparent appearance). The additional clear (overcoat) panel is used to apply a protective surface to the card once the other panels have been deposited.

By appropriate configuration, the printer is also able to print using dye film rolls having a different number or different arrangement of panels within the cycle of colours. For example, a dye film can be used that has only cyan (C), magenta (M), yellow (Y) and black/key (K) colours (CMYK). Alternatively, a dye film can be used that has CMYK colours, an overcoat panel and an additional panel (for example to provide additional watermarking features).

The process of printing using the dye film will now be described.

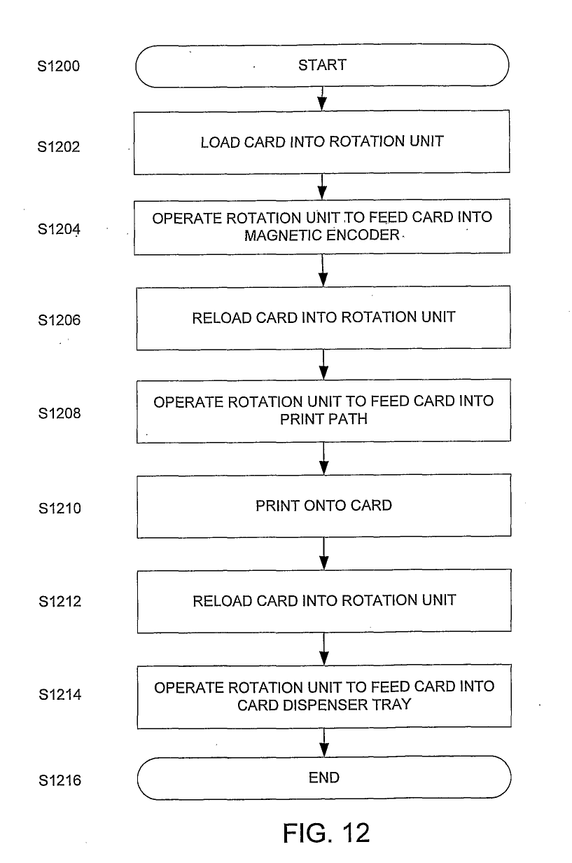

FIG. 12 is a flow diagram illustrating the process of printing a card using the printer of FIG. 1.

The process begins in step S1200, usually in response to receiving a request to print one or more cards from a device (such as a personal computer) attached to the printer. First a card is loaded (step S1202) into the rotation unit by an appropriate means.

The rotation unit is operated (step S1204) by the printer' controller to feed the card into the magnetic encoder, where the magnetic stripe is written. As noted above, if an error in the encoding is discovered, the process ends (the card is rejected and an alert may be generated). The card is then reloaded into the rotation unit (step S1206). If magnetic encoding is not required, steps S1204 and S1206 are omitted.

The card is fed into the main print path (step S1208). The card is printed (step S1210) and reloaded into the rotation unit (step S1212). The rotation unit then deposits the card in the output tray (step S1214) and the process ends (step S1216).

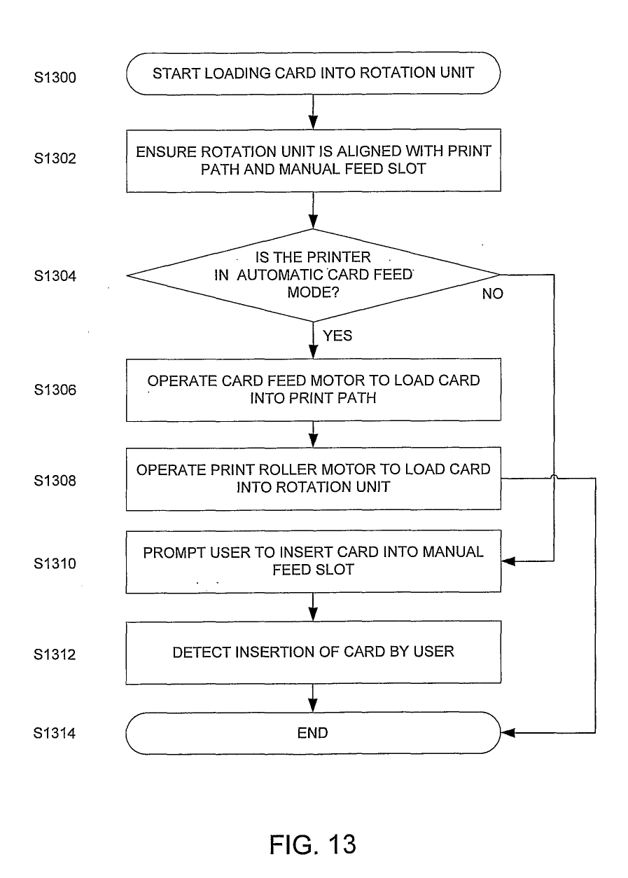

FIG. 13 is a flow diagram illustrating in more detail the process in FIG. 12 of loading a card into the rotation unit.

The process begins in step S1300. The printer controller ensures that the rotation unit is aligned with the main print path and manual feed slot. If the printer is in the automatic feed mode (step S1304), the following steps are followed: the card feeder motor is energised (step S1306) to load a card into the main print path, and the print roller motor is operated by the printer controller (step S1308) to load the card into the rotation unit. The process then ends (step S1314).

Otherwise, for manual feed, the following steps are followed: the print controller prompts the user (via the display unit) to insert a card into the manual feed slot at the front of the printer (step S1310). The printer waits until a card insertion is detected (step S1312), and then the process ends (step S1314).

The selection of manual feed mode may be at the request of the user, for example using control buttons on the printer (which in turn output signals to the printer controller) or by an appropriate control signal transmitted to the printer with the image print data. The selection of manual or automatic feed can be made using printer driver software running on an attached computer, for example.

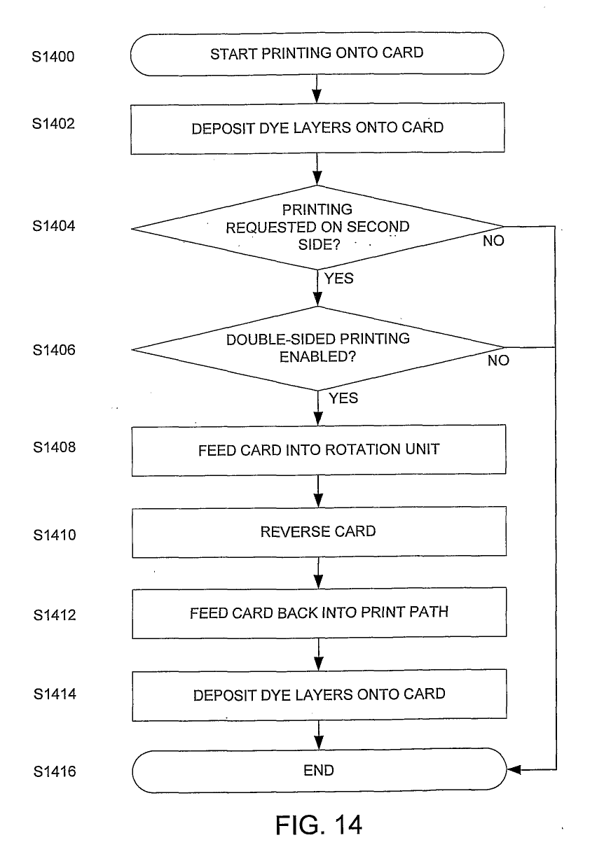

FIG. 14 is a flow diagram illustrating in more detail the process in FIG. 12 of printing onto the card.

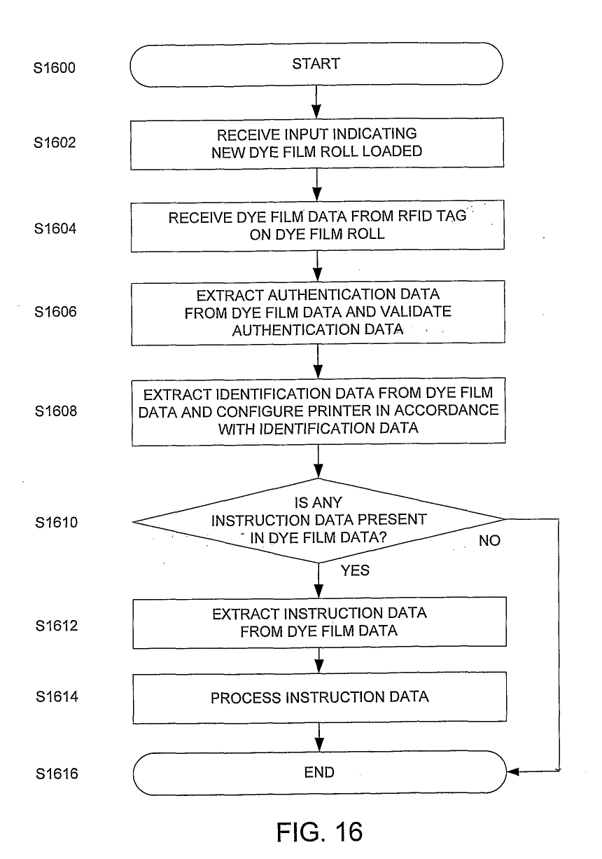

The process begins in step S1400. In step S1402, the various dye layers (typically up to 5 of them) are deposited onto the card. If printing has been requested on the reverse of the card (step S1404), a check is made to see if double-sided printing has been enabled (see below with reference to FIG. 16) in step S1406. If double-sided printing is not requested, or if double-sided printing is not enabled, the process ends (step S1416), and a user alert is generated in the latter case.

If double-sided printing is proceeding, the card is fed into the rotation unit from the main print path (step S1408), and then reversed (by turning the rotation unit 180 degrees) in step S1410. The card is then fed back into the print path (step S1412) and further dye layers are deposited onto the card (step S1414). The process then ends (step S1416).

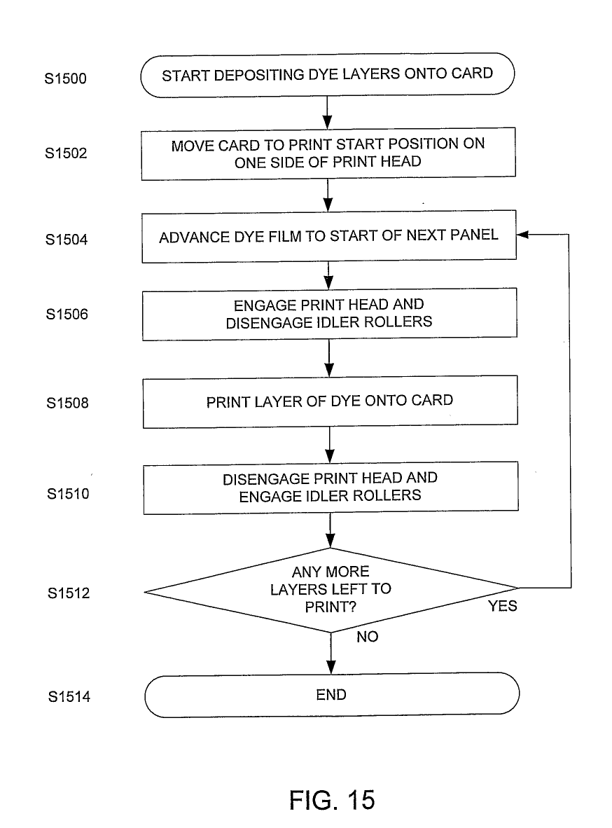

FIG. 15 is a flow diagram illustrating in more detail the process in FIG. 14 of depositing dye layers onto the card.

The process begins in step S1500. Firstly, the card is moved to the print start position to one side of the print head (step S1502) in readiness for printing. The dye film is advanced to the start of the next panel (if that has not already happened) in step S1504, and the print head is engaged and the idler rollers disengaged (step S1506) in order to reduce the damage done to the printed surface during printing. A layer of dye is then printed onto the card (step S1508). As the card advances past the print head, the dye film is wound on so as to continuously expose a ‘fresh’ portion of dye film for printing. After a layer of dye is laid down, the print head is disengaged and the idler rollers are re-engaged (step S1510). If any more layers remain to be printed (step S1512) the process loops back to step S1504, with the dye film being advanced and the card being fed back through the print head. After all layers have been printed (step S1512), the process then ends (step S1514).

The process of loading a new dye film package and also the process of authorising double-sided printing will now be described.

FIG. 16 is a flow diagram illustrating the steps carried out by the print controller of FIG. 1 in response to a new dye film package being loaded.

After the process begins (step S1600), an input is received (step S1602) by the printer controller indicating that a new dye film roll has been loaded. The RFID transceiver mounted next to one of the dye film spools then interrogates the RFID tag embedded in the spool (step S1604) to obtain data (‘dye film data’) from the tag. In step S1606, authentication data is extracted, and then validated. Public key cryptography methods can be used to validate the authenticity of the data contained in the RFID tag. Furthermore encryption methods (based on public key cryptography methods also, or symmetric key encryption) can also be used as appropriate. If the authenticity is not established, then the process is aborted and an error message is generated. In order to avoid potential damage to the printer, the print controller will cease print operations until a dye film package can be successfully authenticated.

In step S1608, identification data is extracted, and the print controller then uses the identification data to make any necessary adjustments to the configuration data stored in the non-volatile memory (or elsewhere). In the present embodiment, the identification data identifies the maker of the dye film package and the type of the dye film package, but in variants of the present embodiment other identification information is provided by the RFID tag.

Instruction data may also be present in the data received from the RFID tag. If any such data exists (step S1610), it is extracted (step S1612) and then processed (step S1614) by the printer controller. The process then ends (step S1616).

In the present embodiment, one class of instruction data is defined: a printer upgrade instruction.

The printer can be shipped in one of two configurations: single-sided and double-sided. Physically the models are essentially identical, but they are differentiated by the use of a double-sided configuration variable that is stored in the non-volatile memory. The process of setting this variable can be carried out during the normal factory testing and calibration process.

The rotation unit is provided in both models because it assists with functions other than reversing the print media (the cards). If the owner of a single-sided model wishes to upgrade to the double-sided model, all they need to do is to purchase a special dye film package with the extra instruction encoded in the RFID tag (for a premium over the normal price of printer consumables). When the dye film package is inserted in the printer, the printer controller executes the instruction and updates the value of the double-sided configuration variable to reflect the new state. The dye film package can then be used as normal.

In variants of the present embodiment, additional instruction types are provided. For example, the RFID tag in the dye film package can contain instructions to enable or disable other printer functionality, cause the printer to attempt to connect to an external device to receive a firmware upgrade (or the like), to cause the printer controller to use a different/new colour profile, and so on. As mentioned above, the RFID tag and RFID transceiver can be replaced by any appropriate alternative such as a barcode and barcode scanner, smartcard and smartcard reader, and so on.

The dye film sensor will now be described in more detail, in particular with regard to the use of multiple colours of the LED.

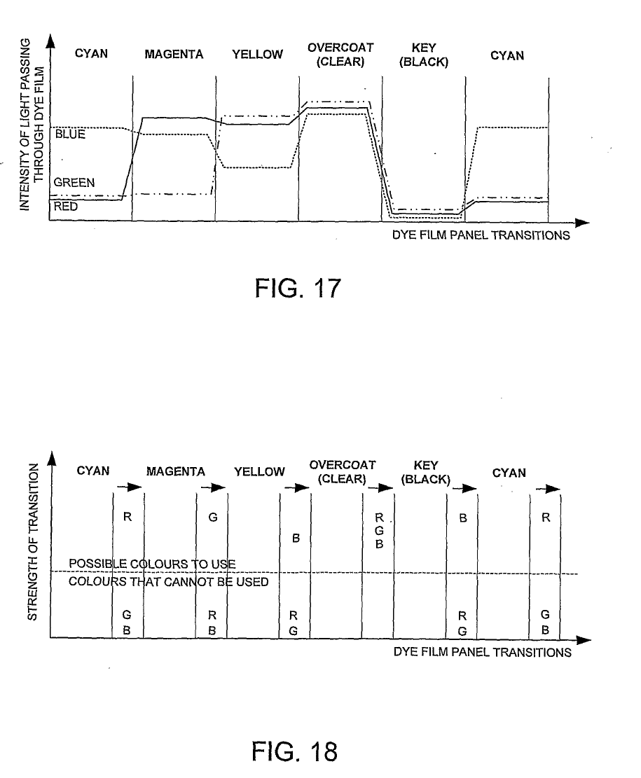

Firstly, FIGS. 17 and 18 will be described by way of background.

FIG. 17 is a graph illustrating the intensity of different colours of light passing through different types of dye film panel.

The horizontal axis of the graph is effectively a measure of length along a dye film roll, and the transitions between different panels of the roll are shown (in the order in which they are normally provided in a roll). In particular, transitions between cyan, magenta, yellow, overcoat key (black) and cyan (again) panels are shown.

The vertical axis of the graph illustrates the (approximate) intensity of light that passes through each of the panels. Lines are plotted for each of the red, green and blue colours emitted by the dye film sensor LED. The intensities plotted are approximate, but illustrate the point that different panels let through different amounts of each of the light sources. For example, cyan has a large blue component, and thus lets a relatively large amount of blue light through, but lets through relatively little red light. Conversely, the magenta panel lets through a relatively large amount of red light, but lets through relatively little green light. The overcoat layer lets through all types of light equally well, and the key/black panel lets through each of the types of light equally poorly.

FIG. 18 is a graph illustrating approximately the strength of the transitions in FIG. 17 between the intensities of the different colours of light during the transition from one dye film panel to the next.

The figure shows diagrammatically the transitions between panels (such as cyan to magenta, magenta to yellow, yellow to overcoat, and so on) and the relative sizes of the transitions in intensity for each of the light sources. For example, the red light source has a relatively large change in intensity (as viewed by the photocell on the other side of the dye film) at the cyan to magenta transition, but it has a relatively small change in intensity moving from magenta to yellow (because both colours contain relatively similar proportions of red). It will be appreciated that different formulations of dye may absorb different colours in varying degrees (and thus the results will differ from those shown in FIGS. 17 and 18), but the general principle will be appreciated.

From FIG. 18 it will be appreciated that there is no one wavelength of light that can reliably detect (that is, will undergo a significant change in light intensity) for all panel transitions. Thus the present embodiment uses a combination of light sources in order to detect transitions between all panel types, as will now be described in more detail.

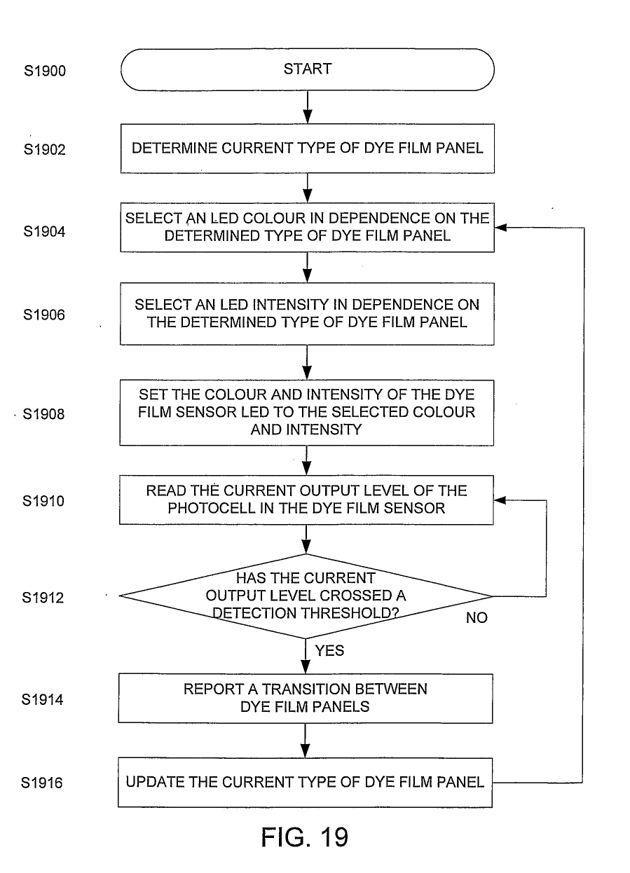

FIG. 19 is a flowchart illustrating a process loop carried out by the print controller of FIG. 1 to detect the transition between different dye film panels.

The loop begins in step S1900. The loop may be implemented as a stand-alone thread or as part of a larger loop executed by the printer controller CPU. Firstly, the current type of dye film panel is determined (step S1902). If the current type is unknown (for example because a new dye film package has just been installed), the current type can be determined for example by testing the dye film with the LED settings for each of the panel types in turn (see below).

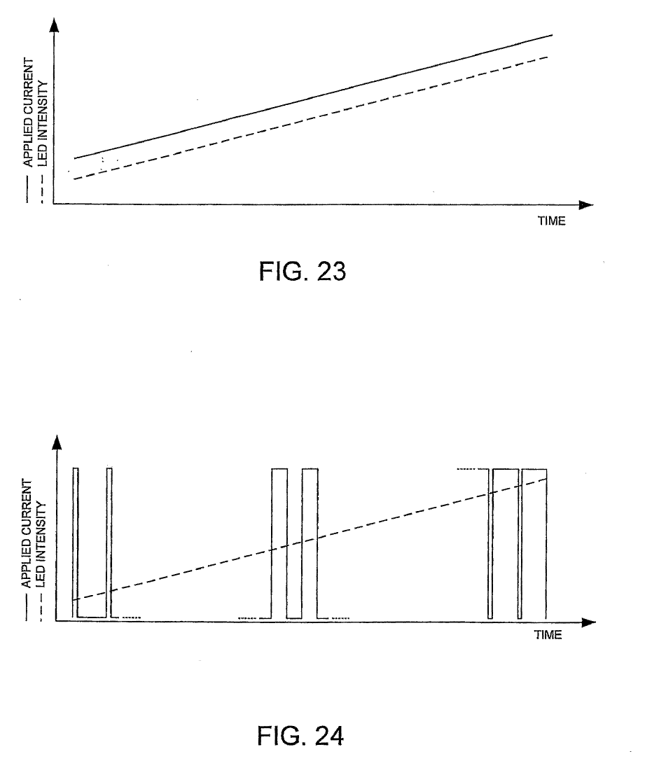

In step S1904 an LED colour (red, green or blue) is selected in dependence on the determined current type of dye film panel. Secondly, an LED intensity is selected (step S1906) also in dependence on the current type of dye film panel. The colour and intensity may advantageously be selected from a look-up table in any of the printer controller data stores that is addressed by panel type, for example. The dye film sensor LED is then set to the selected colour and intensity (step S1908). The method of setting the intensity is described below with reference to FIGS. 23 and 24.

The process then enters a loop in which the current output level of the dye film sensor photocell is read (step S1910), and then processed to see if a threshold has been crossed (step S1912). If the threshold is not crossed, the loop repeats (jumps to step S1910). For performance reasons there may be a delay between steps S1912 and S1910, for example. In the present embodiment, the current output level of the photocell is either 1 (the amount of light received is above a detection threshold) or 0 (the amount of light received is below a detection threshold). In variants of the present embodiment, the current output level is a value within a defined range (converted into a digital value by an analog-to-digital converter) and there is an additional step of comparing the output level to a defined threshold level.

If the output level crosses the detection threshold (rising or falling), the transition between panels is reported to other processes in the print controller (or else simply an appropriate action is taken by the print controller) in step S1914. The current type of dye film panel is then updated (step S1916) and the process jumps back to step S1904.

For simplicity, only one colour of the LED is illuminated at any one time. However, in a variant of the present embodiment, more than one colour is illuminated at any one time. For example, the red, green and blue colours can be combined to approximate the cyan, magenta and yellow colours of the relevant dye film panels (green and blue approximating to the cyan, red and blue approximating to the magenta, and red and green approximating to the yellow). It will also be appreciated from FIG. 18 that more than one sequence of LED colours is possible in order to differentiate between all of the distinct panels.

In a variant of the present embodiment, a tachometer on one of the dye film spools is used to estimate the amount of dye film that is wound on and thus to estimate the point at which a panel transition occurs. This method is combined with the dye film sensor because the variation in the thickness of the roll wound on each spool varies over time and thus creates a margin of error in the estimate based on the tachometer reading. In another variant the tachometer reading alone is used and may be compensated, for example, using information about the total number of rotations carried out for a particular dye film package (allowing the spool radius to be estimated).

The process by which the LED intensities are derived for step S1906 will now be described.

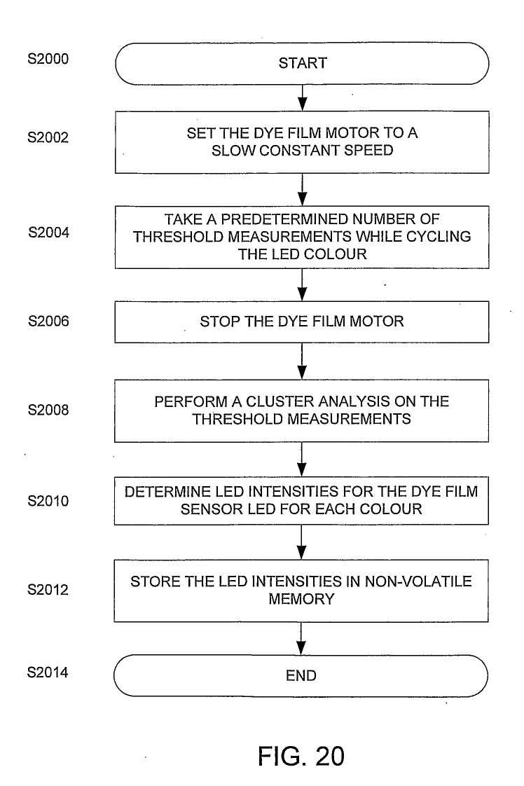

FIG. 20 is a flowchart illustrating a calibration process for determining the LED intensities used in the loop of FIG. 19. This process is normally carried out during a printer calibration phase, which is undertaken in the factory but may also be repeated at a later event to compensate for any component drift and the like that is experienced over time.

After the process begins (step S2000), the dye film motor is set to a slow constant speed (step S2002). In this context ‘slow’ means slow enough that the LED colours can be cycled several times at least between panel transitions. A predetermined number of LED threshold intensity measurements are then taken (step S2004) while cycling the LED colour between red, green and blue colours. (The ‘threshold intensity’ is the intensity of the LED that causes the associated photocell to switch from a 0 to a 1 state.) The dye film motor is then stopped (step S2006).

A cluster analysis is carried out (by an attached workstation, rather than by the print controller, although the latter is possible) on a matrix of records R, G and B values to identify clusters of sample points (step S2008). Except for some transitions between panels, the R, G and B values all relate to the same colour of panel. The R, G and B values are considered conceptually to correspond to a point in three dimension space with axes defined by the R, G and B threshold values. There will be some variation in R, G and B values for a particular colour panel due to noise effects and also variation in the consistency of colour in each panel. When the clusters are identified, the corresponding colour of panel can also be identified in dependence on the relative position of the cluster within the three-dimensional space.

After the clusters are identified, LED intensities for the dye film sensor LED (one for each colour, as used in the process illustrated in FIG. 19) are then computed in step S2010. The process by which this is done is explained in more detail below. The LED intensities are then stored in non-volatile memory (step S2012) for use by the process of FIG. 19. The process then ends (step S2014).

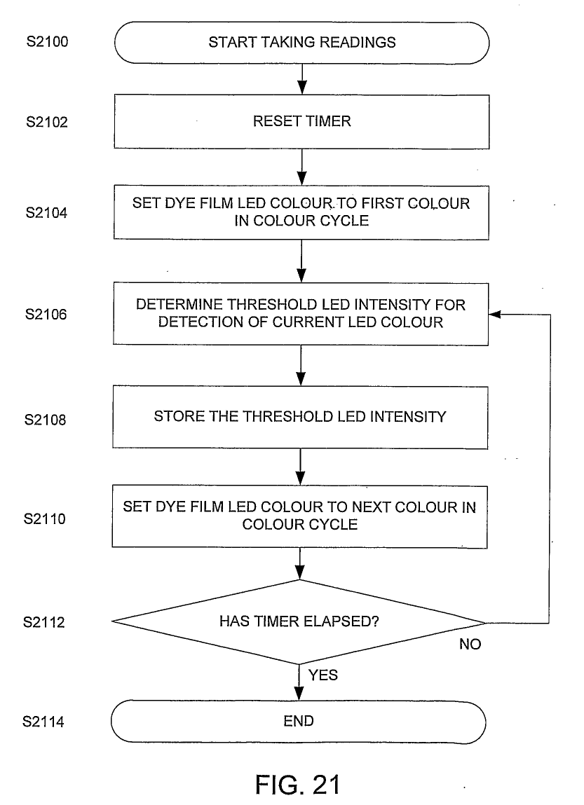

FIG. 21 is a flowchart illustrating in more detail the process in FIG. 20 of taking readings from the dye film sensor photocell.

After the process begins (step S2100), a timer is reset to a predetermined value (which may be a number of seconds or minutes, for example) in step S2102. This timer determines how many samples are taken. Alternatively, a target number of samples may be specified, or there may be no limit, and the process may be carried out as long as there is dye film left in the dye film package, for example. It will be appreciated that the following steps can be modified as appropriate.

In step S2104 the dye film sensor LED is set to the first colour in the colour cycle (red, for example). A threshold LED intensity is then determined for that colour (step S2106), as is explained in more detail below. The threshold LED intensity is then stored (step S2108). The dye film LED colour is set to the next colour in the cycle (such as green, for example) in step S2110. If the timer (or equivalent) has not yet elapsed, the process loops back to step S2106. Otherwise the process ends (step S2108).

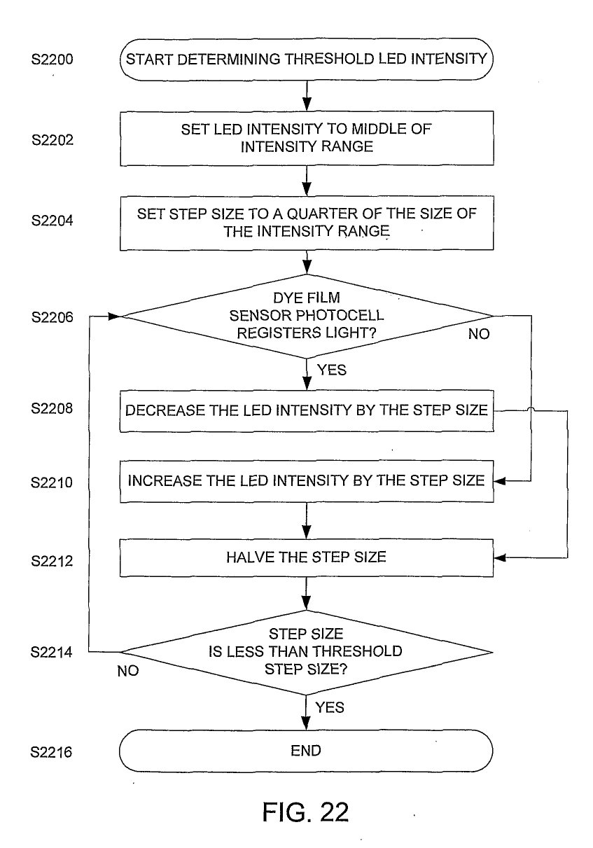

FIG. 22 is a flowchart illustrating in more detail the process in FIG. 21 of determining the threshold LED intensity for a particular LED colour.

In the present embodiment, a form of a bisecting algorithm is used to establish the LED intensity threshold mentioned above, as will now be described.

After the process begins (step S2200), the LED intensity is set to the middle of the range of possible intensities (step S2202). For example, if the maximum intensity is 1 and the minimum intensity is 0, the LED intensity is set to 0.5. A step size variable is then set to a quarter of the intensity range (in this example, it is set to 0.25) in step S2204. The dye film sensor photocell is then tested (step S2206). If the photocell threshold is exceeded, then the LED intensity is decreased by the step size (in this example, it is reduced to 0.25) in step S2208. Otherwise the LED intensity is increased by the step size (in this example, it is increased to 0.75) in step S2210. The step size is then halved in step S2212 (so the step size becomes 0.125, for example).

If the step size is not less than a threshold value (in this example a value such as 0.01 or 0.02, for example) then the process loops back to step S2206. Otherwise the process ends (step S2216) with the LED intensity having been adjusted by the algorithm to within the specified degree of accuracy (0.01 or 0.02 in this example). Essentially, this algorithm ‘zooms in’ on the LED intensity threshold by making successively smaller adjustments to the intensity value in dependence on the output of the photocell.

Other algorithms can of course be used in determining the LED intensity threshold.

The method used in the present embodiment for applying the requested LED intensity will now be described.

FIG. 23 is a graph illustrating the approximate relationship between the current applied to an LED and the intensity of the LED for a linearly increasing current.

This illustrates that (approximately) the more current that is supplied to an LED, the greater the intensity of the LED. Where the relationship is not linear (that is, not like the relationship pictured in FIG. 23), a look-up table or similar can be used to correct for the non-linearity.

An LED with a variable current supply thus provides a straightforward means of varying the intensity of an LED. However, the circuitry is not entirely straightforward and adds extra cost to the design of the motherboard. An alternative means of varying the LED intensity will now be described.

FIG. 24 is a graph illustrating the approximate relationship between the current applied to an LED and the intensity of the LED for a pulse width modulated current having a linearly increasing mark/space ratio.

This illustrates the output of an LED which is supplied by an input voltage that is turned on and off using a pulse width modulation scheme. Provided that the modulation occurs at a sufficiently high frequency, the (apparent) intensity of the LED, at least as observed by the photocell, is approximately proportional to the ratio of time spent switched on to the time spent switched off, as illustrated in the figure.

This is the control scheme used to vary the intensity of the dye film sensor LED, although other appropriate arrangements (such as the variable current supply) can of course be used.

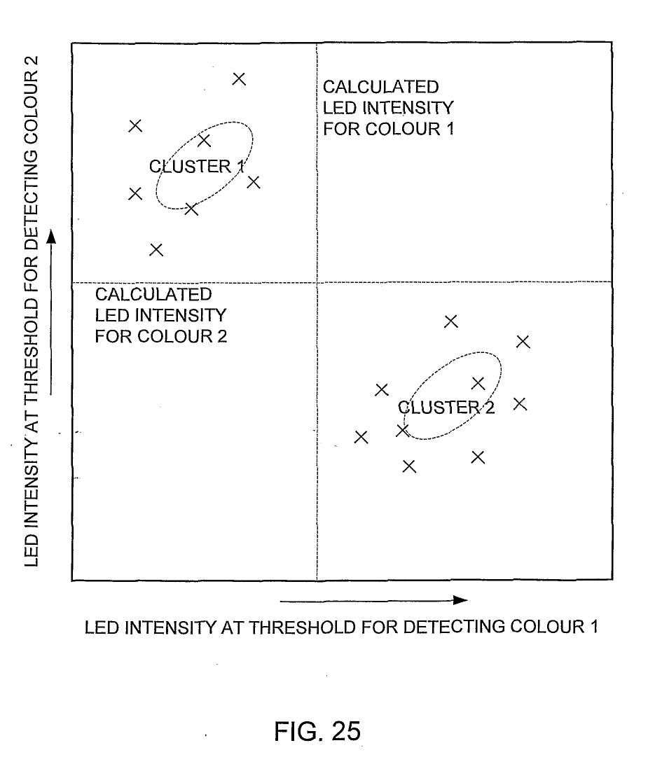

FIG. 25 is an illustration of the cluster analysis process of FIG. 20, mentioned above in step S2008 of FIG. 20.

For clarity, only two colours (red and green, say) are considered, so the samples of LED intensity obtained in FIG. 20 can be plotted in a two-dimensional space, as illustrated in FIG. 25. The ‘X’ shapes mark the position of sample pairs in the (colour 1, colour 2) space. The dotted oval shapes represent an approximate estimate of the cluster centres and variances for two clusters that might be identified. Here, cluster 1 relates to a cluster associated with a dye film panel of a first type, and cluster 2 relates to a cluster associated with a dye film panel of a second type. If the first colour (colour 1) is red and the second colour (colour 2) is green, then cluster 1 may relate to a cyan panel (high green content, low red content) and cluster 2 may relate to a magenta panel (high red content, low green content), for example.

When the clusters have been identified (and also classified into panel colours based on their relative positions), threshold LED intensities can then be calculated (shown as horizontal and vertical dashed lines) which give the statistically best chance of distinguishing between the different clusters (panel types). The positions of these calculated threshold LED intensities along the horizontal and vertical axis (and third axis, in the real case) are then stored and used as the values selected in step S1906 of FIG. 19, for example.

As noted, the above example is two-dimensional only, but similar principles apply to the three-dimensional situation that applies to the printer.

In the present embodiment, the above-described calibration process is used only during factory configuration, but it will be appreciated that if the analog dye film sensor photocell output is measured by the printer controller (rather than just the binary comparison output) then the calibration method can be carried out periodically or continuously, as the sample values obtained during use can be stored in a running buffer of samples, and the cluster analysis and recalibration of the LED intensity values can be undertaken on a periodic basis.

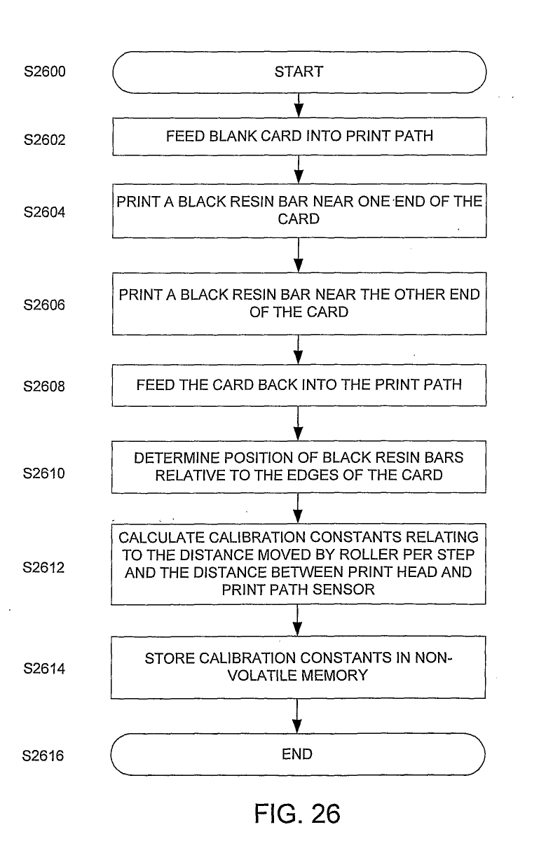

FIG. 26 is a flowchart illustrating a calibration process for calibrating the printer of FIG. 1.

This calibration process is required because there may be manufacturing tolerances affecting to the distance between the print path sensor and the print head, and also tolerances affecting the width of the print rollers (which affects the distance moved by the surface of the rollers per step of the associated stepper motor). The present process allows calibration constants and the like to be generated to compensate for any variations. A calibration workstation may be used to assist with part of the process that will now be described.

After the calibration process begins (step S2600) a blank card is fed into the print path (step S2602). A black resin bar (a stripe widthwise along the card) is printed near one end of the card (step S2604) and then a second black resin bar is printed near the other end of the card (step S2606). The card is then fed back into the print path (step S2608) and the print path sensor is used to determine the position of the black resin bars relative to the edges of the card (step S2610). This information is then used to calculate calibration constants relating to the distance moved by the rollers per step of the stepper motor, and the distance between the print head and the print path sensor (step S2612). The calibration constants are then stored in non-volatile memory (step S2614) for later use by the printer controller. The process then ends (step S2616).

The calibration process is made easier by varying the power of the print path sensor LED (using a pulse width modulation method as described above, although other techniques are of course possible). Before the first card edge is detected, the LED intensity is set to a first, relatively low level. When the card edge is detected (by the photocell output going from a 1 to a 0, indicating that the received light level has dropped below a threshold amount because the light is now blocked by the card), the current number of steps moved by the roller is noted, and the LED intensity is set to a second, relatively high level. The second level is such that sufficient light passes through the card to cause the photocell to output a ‘1’ again (indicating that the amount of light received is over the threshold amount). When the card advances to the point that the black resin bar is between the LED and photocell, the amount of light passing through the card is diminished, and the photocell switches to a ‘0’ output again. The output returns to a ‘1’ when the resin bar passes by. When the next resin bar approaches, the photocell switches to a ‘0’ and back to ‘1’ again. At this point, the LED intensity is reset to the first level, causing the output to change back to a ‘0’ (because not enough light passes through the card to activate the photocell). When the trailing edge of the card leaves the gap between the LED and photocell, a final transition back to a ‘1’ state occurs. The relative timings and/or step counts between the transitions mentioned above is used to calculate the calibration constants.

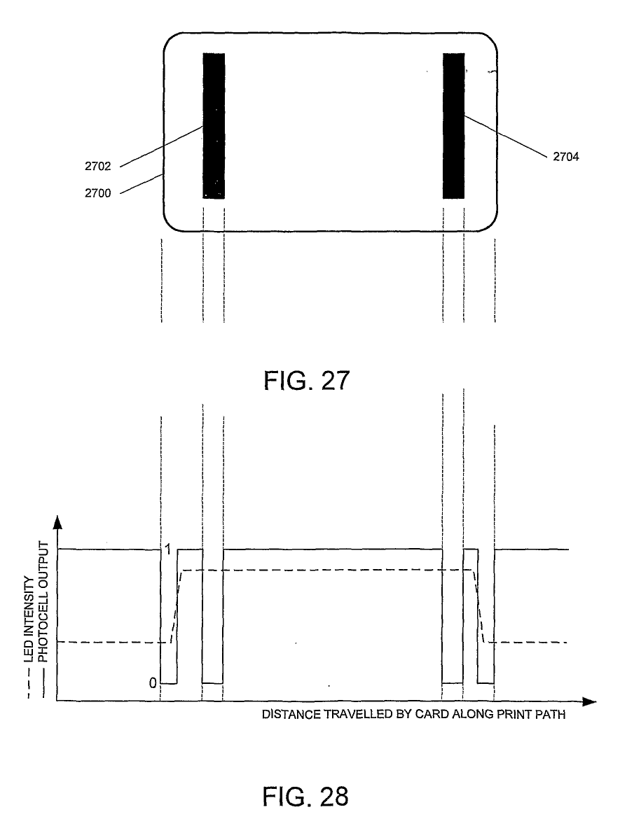

This process will now be illustrated with reference to FIGS. 27 and 28.

FIG. 27 is an illustration of a card printed using the process of FIG. 26.

The card 2700 is shown with the two resin bars 2702, 2704 printed onto it. The dashed lines extending from the figure are to facilitate a comparison between the present figure and the next.

FIG. 28 is an illustration of the LED output intensity and the photocell output that is used as the card of FIG. 27 is scanned through the print path.

The horizontal axis represents the portion of the card that is scanned by the print path sensor at any given point as the card passes through the sensor. The axis has been aligned with the horizontal location on the card of FIG. 27 for easy comparison.

The vertical axis approximately represents the preset LED intensity, shown here alternating between the first and second level (the dashed line), and also represents the output of the photocell, shown here alternating between ‘0’ and ‘1’ (the solid line). The transitions in the photocell output can be observed in the solid line plot in FIG. 28 as the card is scanned past the sensor. The transition of the LED intensity (dashed line) between the first and second intensity has been exaggerated for clarity (a step change is made, rather than a gradual transition).

It will be appreciated that the photocell can alternatively output an analog value in a given range (rather than a binary or on/off value) and the process may further include comparing the analog value to a predetermined threshold value. With sufficient dynamic range in the photocell output (and sufficiently low noise levels) it will be appreciated that the dye path sensor LED in one variant can be set to a single intensity level for the duration of the calibration process (and operation).

The present embodiment relates to a dye sublimation printer, but it will be appreciated that many of the principles described above can be applied where appropriate to inkjet or other appropriate printing technologies, and can be applied in appropriate circumstances to other types of print media other than plastic cards (such as paper, product labelling, and so on).

Various embodiments and variants have been described above. However, it is not intended that the invention be limited to these embodiments. Further modifications lying within the spirit and scope of the present invention will be apparent to a skilled person in the art. The features of the above described arrangements may be combined in various ways to provide similar advantages in alternative arrangements.

1. A printer, comprising
a print unit for printing on a print medium;
a print media reversal unit for reversing the print medium to allow double-sided printing onto the print medium;
a memory unit for storing printer configuration data, the printer configuration data including data specifying whether or not the printer is permitted to operate in a double-sided printing mode;
an input device for receiving an instruction to permit the operation of the printer in a double-sided printing mode; and
a print controller for controlling the print unit and the print media rotation unit, the controller being programmed to operate the printer in either a single-sided or double-sided mode in dependence on the printer configuration data, and to update the printer configuration data appropriately in response to receiving the instruction to permit the operation of the printer in a double-sided printing mode.

2. A printer according to claim 1, further comprising a mount for receiving a printer consumable package, and wherein the input device is operable to receive the instruction from a computer-readable tag in the printer consumable package.

3. A printer according to claim 2, wherein the input device is operable to receive authentication information from the computer-readable tag, and the print controller is further programmed to process the authentication information and to enable or disable the operation of the printer in conjunction with the printer consumable package in dependence on the processing.

4. A printer according to claim 1, wherein:
the print unit includes a first pair of rollers for gripping the print medium during printing;
the print media reversal unit includes a second pair of rollers for gripping the print medium while it is being reversed; and
the second pair of rollers is arranged additionally to grip the print medium while the print unit is printing on the print media.

5. A printer, comprising
a print unit for printing on a print medium, including a first pair of rollers for gripping the print medium during printing; and
a print media reversal unit for reversing the print medium to allow double-sided printing onto the print medium, the print media reversal unit including a second pair of rollers for gripping the print medium while it is being reversed,
wherein the second pair of rollers is arranged additionally to grip the print medium while the print unit is printing on the print media.

6. A printer according to claim 1 or claim 5, further comprising a data encoder unit for encoding data into a data carrier in the print medium, and wherein the print media reversal unit is operable to feed the print medium into the data encoder unit.

7. A printer according to claim 1 or claim 5, wherein:
the print unit is operable to imprint printer consumable material onto a print medium, and the print unit is arranged such that, in use, the print medium passes through the print unit in a defined print path;
the printer further comprises:
a variable power emitter of electromagnetic radiation, the emitter being arranged on a first side of the print path; and
a detector of the electromagnetic radiation, the detector being arranged on a second side of the print path and outputting a detection signal;
the print medium has a first opacity to the electromagnetic radiation, and the print medium with the printer consumable material imprinted on it has a second opacity to the electromagnetic radiation; and
the print controller is programmed to set the power of the emitter to one of a first power level and a second power level in dependence on the first opacity and second opacity, such that when the emitter is set to the first power level the detector can detect the presence or absence of the print medium, and when the emitter is set to the second power level the detector can detect the presence or absence of the printer consumable material on the print medium.

8. A printer, comprising:
a print unit for imprinting printer consumable material onto a print medium, the print unit being arranged such that, in use, the print medium passes through the print unit in a defined print path;
a variable power emitter of electromagnetic radiation, the emitter being arranged on a first side of the print path;
a detector of the electromagnetic radiation, the detector being arranged on a second side of the print path and outputting a detection signal; and
a print controller for controlling the print unit, the variable power emitter and the detector, and receiving the detection signal,
wherein the print medium has a first opacity to the electromagnetic radiation, and the print medium with the printer consumable material imprinted on it has a second opacity to the electromagnetic radiation, and
the print controller is programmed to set the power of the emitter to one of a first power level and a second power level in dependence on the first opacity and second opacity, such that when the emitter is set to the first power level the detector can detect the presence or absence of the print medium, and when the emitter is set to the second power level the detector can detect the presence or absence of the printer consumable material on the print medium.

9. A printer according to claim 8, further comprising a print media transport unit for transporting the print medium along the print path, the print media transport unit being controllable by the print controller to transport the print medium by a number of steps specified by the print controller, each step corresponding to a distance along the print path.

10. A printer according to claim 9, wherein the printer controller is further programmed to:
set the power of the emitter to the first power level;
control the print media transport unit to transport a print medium of a defined length through the print path;
process the detection signal to identify transitions in the detection signal corresponding to edges of the print medium passing between the emitter and the detector, and to identify the number of steps carried out by the print media transport unit between the transitions; and
process the identified transitions and identified number of steps to calculate the distance moved by the print medium per step carried out by the print media transport unit.

11. A printer according to claim 9, for use with a print medium of a defined first length having the printer consumable material imprinted on a first print area and a second print area, the first and second print areas being separated by a second length, and wherein the print controller is further programmed to:
set the power of the emitter to the second power level;
control the print media transport unit to transport the print medium through the print path;
process the detection signal to identify transitions in the detection signal corresponding to the first and second print areas of the print medium passing between the emitter and the detector, and to identify the number of steps carried out by the print media transport unit between the transitions; and
process the identified transitions and identified number of steps to calculate the distance moved by the print medium per step carried out by the print media transport unit.

12. A printer according to claim 11, wherein the print unit includes a print head, the print controller is further programmed to control the print unit and the print media transport unit to imprint the first and second print areas on the print medium, and to process the identified transitions to calculate a value related to a distance along the print path between the print head and the emitter and detector.

13. A printer according to claim 11, wherein the print controller is further programmed to process the identified transitions to determine the distance between the first print area and the edge of the print medium

14. A printer according to any one of claim 1, 5, or 8, wherein the print controller is further programmed to:
calculate calibration constants relating to the print unit; and
store the calibration constants.

15. A printer according to any one of claims, 1, 5 or 8, further comprising a manual print feed unit, arranged in conjunction with the print media reversal unit to allow a user to feed a print medium into the second pair of rollers.

16. A printer, comprising:
a print unit for printing on a print medium;
a print media reversal unit for reversing the print medium to allow double-sided printing onto the print medium, the print media reversal unit including at least one pair of rollers for gripping the print medium while it is being reversed, and
a manual print feed unit, arranged in conjunction with the print media reversal unit to allow a user to feed a print medium into a said pair of rollers.

17. A printer according to claim 16, wherein the print media reversal unit is rotatable around a pivot, and has a substantially convex profile in the plane of the pivot except for at least one opening for receiving the manually fed print medium.

18. A printer according to claim 16, wherein the manual print feed unit includes a selectively releasable shutter for preventing insertion of the print medium by the user, the shutter being releasable when the print media reversal unit is in a predetermined orientation relative to the manual print feed unit.

19. A printer according to any one of claim 1, 5, 8 or 16 for use with a printer consumable material including a substantially transparent substrate and a plurality of regions of printable material embedded on the substrate, each of the regions being coloured a particular colour, and wherein:
the print unit is arranged such that, in use, the substrate passes through the print unit in a defined printer consumable feed path;
the printer further comprises:
a multi wavelength emitter for selectively emitting a plurality of wavelengths of electromagnetic radiation, the multi wavelength emitter being arranged on a first side of the printer consumable feed path; and
a multi wavelength detector for detecting the emitted electromagnetic radiation, the multi wavelength detector being arranged on a second side of the printer consumable feed path and outputting a detection signal;
the print controller is programmed to:
select a wavelength from the plurality of wavelengths of electromagnetic radiation;
control the multi wavelength emitter to emit the selected wavelength; and
process the multi wavelength detection signal to calculate the colour of the region between the multi wavelength emitter and the multi wavelength detector.

20. A printer for use with a printer consumable material, the printer consumable material including a substantially transparent substrate and a plurality of regions of printable material embedded on the substrate, each of the regions being coloured a particular colour, and the printer comprising:
a print unit for imprinting the printable material onto a print medium, the print unit being arranged such that, in use, the substrate passes through the print unit in a defined printer consumable feed path;
a multi wavelength emitter for selectively emitting a plurality of wavelengths of electromagnetic radiation, the multi wavelength emitter being arranged on a first side of the printer consumable feed path;
a multi wavelength detector for detecting the emitted electromagnetic radiation, the multi wavelength detector being arranged on a second side of the printer consumable feed path and outputting a detection signal; and
a print controller for controlling the print unit, the multi wavelength emitter and the multi wavelength detector, and receiving the detection signal,
wherein the print controller is programmed to:
select a wavelength from the plurality of wavelengths of electromagnetic radiation;
control the multi wavelength emitter to emit the selected wavelength; and
process the detection signal to calculate the colour of the region between the multi wavelength emitter and the multi wavelength detector.

21. A printer according to claim 20 for use with a printer consumable medium in which the regions are arranged on the substrate in a defined sequence, and wherein the print controller is programmed to:
monitor the current position in the sequence; and
select the wavelength in dependence on the colour of the next region expected in the sequence.

22. A printer according to claim 20, wherein the print controller is further programmed to repeatedly cycle the selected wavelength and to process the detection signal to estimate a plurality of colour parameters relating to the region between the multi wavelength emitter and the multi wavelength detector.

23. A printer according to claim 22, wherein the detection signal encodes a detection amplitude, and the print controller is further programmed to compare the detection amplitude with a detection threshold to determine the transition between one region and the next.

24. A printer according to claim 22, wherein the print controller is further programmed to change the detection threshold in dependence on the detection amplitude.

25. A printer for use with a printer consumable material, the printer consumable material including a substantially transparent substrate and a plurality of regions of printable material embedded on the substrate, each of the regions being coloured a particular colour, and the printer comprising:
a print unit for imprinting the printable material onto a print medium, the print unit being arranged such that, in use, the substrate passes through the print unit in a defined printer consumable feed path;
an emitter for selectively emitting a plurality of wavelengths of electromagnetic radiation, the emitter being arranged on a first side of the printer consumable feed path;
a detector for detecting the emitted electromagnetic radiation, the detector being arranged on a second side of the printer consumable feed path and outputting a detection signal; and
a print controller for controlling the print unit, the emitter and the detector, and receiving the detection signal,
wherein the print controller is programmed to carry out a calibration sequence including the steps of:
iterating for a number of times through the steps of:
selecting a wavelength from the plurality of wavelengths of electromagnetic radiation, the selected wavelength being selected in a cyclic fashion;
controlling the emitter to emit the selected wavelength;
storing the detection signal received from the detector; and
advancing the substrate of the printer consumable material; and
processing the stored detection signals to calculate at least one detection threshold for detecting transitions between the different regions of the substrate.

26. A printer according to claim 25, wherein the print controller is further programmed to process the stored detection signals using a statistical cluster analysis.

27. A printer according to claim 25, wherein the print controller is operable in a printing mode in which it is programmed to:
select a wavelength from the plurality of wavelengths of electromagnetic radiation;
control the emitter to emit the selected wavelength; and
process the detection signal in dependence on said at least one detection threshold to calculate the colour of the region between the emitter and the detector.

28. A printer according to claim 25, wherein the detection signal encodes a detection amplitude, and the print controller is further programmed to compare the detection amplitude with a said detection threshold to determine the transition between one region and the next.

29. A printer according to claim 25, wherein the print controller is programmed to restart the calibration sequence in response to a predefined event.

30. A printer consumable package, comprising:
printer consumable material; and
a computer-readable tag, the computer-readable tag encoding instruction data to instruct the printer to permit printing in a double-sided mode.

31. A printer consumable package according to claim 30, wherein the computer-readable tag also encodes authentication information.

32. A method of operating a printer, the printer comprising a print unit for printing on a print medium, a print media reversal unit for reversing the print medium to allow double-sided printing onto the print medium, a memory unit for storing printer configuration data, the printer configuration data including data specifying whether or not the printer is permitted to operate in a double-sided printing mode, an input device for receiving an instruction to permit the operation of the printer in a double-sided printing mode, and a print controller for controlling the print unit and the print media rotation unit, and the method comprising:
operating the printer in either a single-sided or double-sided mode in dependence on the printer configuration data; and
updating the printer configuration data appropriately in response to receiving the instruction to permit the operation of the printer in a double-sided printing mode.

33. A method according to claim 32, further comprising receiving the instruction from a computer-readable tag in a printer consumable package.

34. A method according to claim 32, further comprising receiving authentication information from the computer-readable tag, and processing the authentication information and to enable or disable the operation of the printer in conjunction with the printer consumable package in dependence on the processing.

35. A method according to claim 32, the print unit including a first pair of rollers for gripping the print medium during printing, the print media reversal unit including a second pair of rollers for gripping the print medium while it is being reversed, and further comprising operating the second pair of rollers to grip the print medium while the print unit is printing on the print media.

36. A method of operating a printer, the printer comprising a print unit for printing on a print medium, including a first pair of rollers for gripping the print medium during printing, and a print media reversal unit for reversing the print medium to allow double-sided printing onto the print medium, the print media reversal unit including a second pair of rollers for gripping the print medium while it is being reversed, and the method comprising operating the second pair of rollers to grip the print medium while the print unit is printing on the print media.

37. A method according to claim 32, the printer further comprising a data encoder unit for encoding data into a data carrier in the print medium, and the method further comprising operating the print media reversal unit to feed the print medium into the data encoder unit.

38. A method according to claim 32, the print unit being operable to imprint printer consumable material onto a print medium, the print unit being arranged such that, in use, the print medium passes through the print unit in a defined print path, the printer further comprising a variable power emitter of electromagnetic radiation, the emitter being arranged on a first side of the print path, and a detector of the electromagnetic radiation, the detector being arranged on a second side of the print path and outputting a detection signal, the print medium having a first opacity to the electromagnetic radiation, and the print medium with the printer consumable material imprinted on it having a second opacity to the electromagnetic radiation, and the method further comprising:
setting the power of the emitter to one of a first power level and a second power level in dependence on the first opacity and second opacity, such that when the emitter is set to the first power level the detector can detect the presence or absence of the print medium, and when the emitter is set to the second power level the detector can detect the presence or absence of the printer consumable material on the print medium.

39. A method of operating a printer including a print unit for imprinting printer consumable material onto a print medium, the print unit being arranged such that, in use, the print medium passes through the print unit in a defined print path, a variable power emitter of electromagnetic radiation, the emitter being arranged on a first side of the print path, a detector of the electromagnetic radiation, the detector being arranged on a second side of the print path and outputting a detection signal, and a print controller for controlling the print unit, the variable power emitter and the detector, and receiving the detection signal, the print medium having a first opacity to the electromagnetic radiation, and the print medium with the printer consumable material imprinted on it having a second opacity to the electromagnetic radiation, and the method comprising:
setting the power of the emitter to one of a first power level and a second power level in dependence on the first opacity and second opacity, such that when the emitter is set to the first power level the detector can detect the presence or absence of the print medium, and when the emitter is set to the second power level the detector can detect the presence or absence of the printer consumable material on the print medium.

40. A method according to claim 39, the printer further comprising a print media transport unit for transporting the print medium along the print path, and the method further comprising controlling the print media transport unit to transport the print medium by a specified number of steps, each step corresponding to a distance along the print path.

41. A method according to claim 40, further comprising:
setting the power of the emitter to the first power level;
controlling the print media transport unit to transport a print medium of a defined length through the print path;
processing the detection signal to identify transitions in the detection signal corresponding to edges of the print medium passing between the emitter and the detector, and to identify the number of steps carried out by the print media transport unit between the transitions; and
processing the identified transitions and identified number of steps to calculate the distance moved by the print medium per step carried out by the print media transport unit.

42. A method according to claim 40, for use with a print medium of a defined first length having the printer consumable material imprinted on a first print area and a second print area, the first and second print areas being separated by a second length, and wherein the method further comprises:
setting the power of the emitter to the second power level;
controlling the print media transport unit to transport the print medium through the print path;
processing the detection signal to identify transitions in the detection signal corresponding to the first and second print areas of the print medium passing between the emitter and the detector, and to identify the number of steps carried out by the print media transport unit between the transitions; and
processing the identified transitions and identified number of steps to calculate the distance moved by the print medium per step carried out by the print media transport unit.

43. A method according to claim 42, the print unit including a print head, and the method further comprising controlling the print unit and the print media transport unit to imprint the first and second print areas on the print medium, and processing the identified transitions to calculate a value related to a distance along the print path between the print head and the emitter and detector.

44. A method according to claim 42, further comprising processing the identified transitions to determine the distance between the first print area and the edge of the print medium.

45. A method according to any one of claims 32, 36, or 39, further comprising calculating calibration constants relating to the print unit; and storing the calibration constants.

46. A method according to any one of claims 32, 36 or 39, the printer further comprising a manual print feed unit, and the method further comprising operating the print media reversal unit to allow a user to feed a print medium into the second pair of rollers.

47. A method of operating a printer, the printer comprising a print unit for printing on a print medium, a print media reversal unit for reversing the print medium to allow double-sided printing onto the print medium, the print media reversal unit including at least one pair of rollers for gripping the print medium while it is being reversed, and a manual print feed unit, the method comprising operating the print media reversal unit to allow a user to feed a print medium into a said pair of rollers.

48. A method according to claim 47, the manual print feed unit including a selectively releasable shutter for preventing insertion of the print medium by the user, and the method further comprising releasing the shutter when the print media reversal unit is in a predetermined orientation relative to the manual print feed unit.

49. A method according to any one of claims 32, 36, 39 or 47 for use with a printer consumable material including a substantially transparent substrate and a plurality of regions of printable material embedded on the substrate, each of the regions being coloured a particular colour, the print unit being arranged such that, in use, the substrate passes through the print unit in a defined printer consumable feed path, the printer further comprising a multi wavelength emitter for selectively emitting a plurality of wavelengths of electromagnetic radiation, the multi wavelength emitter being arranged on a first side of the printer consumable feed path; and a multi wavelength detector for detecting the emitted electromagnetic radiation, the multi wavelength detector being arranged on a second side of the printer consumable feed path and outputting a detection signal, and wherein the method further comprises:
selecting a wavelength from the plurality of wavelengths of electromagnetic radiation;
controlling the multi wavelength emitter to emit the selected wavelength; and
processing the multi wavelength detection signal to calculate the colour of the region between the multi wavelength emitter and the multi wavelength detector.

50. A method of operating a printer for use with a printer consumable material, the printer consumable material including a substantially transparent substrate and a plurality of regions of printable material embedded on the substrate, each of the regions being coloured a particular colour, the printer comprising a print unit for imprinting the printable material onto a print medium, the print unit being arranged such that, in use, the substrate passes through the print unit in a defined printer consumable feed path, a multi wavelength emitter for selectively emitting a plurality of wavelengths of electromagnetic radiation, the multi wavelength emitter being arranged on a first side of the printer consumable feed path, a multi wavelength detector for detecting the emitted electromagnetic radiation, the multi wavelength detector being arranged on a second side of the printer consumable feed path and outputting a detection signal; and a print controller for controlling the print unit, the multi wavelength emitter and the multi wavelength detector, and receiving the detection signal, and the method comprising:
selecting a wavelength from the plurality of wavelengths of electromagnetic radiation;
controlling the multi wavelength emitter to emit the selected wavelength; and
processing the detection signal to calculate the colour of the region between the multi wavelength emitter and the multi wavelength detector.

51. A method according to claim 50 for use with a printer consumable medium in which the regions are arranged on the substrate in a defined sequence, and wherein the method further comprises:
monitoring the current position in the sequence; and
selecting the wavelength in dependence on the colour of the next region expected in the sequence.

52. A method according to claim 49, further comprising repeatedly cycling the selected wavelength and processing the detection signal to estimate a plurality of colour parameters relating to the region between the multi wavelength emitter and the multi wavelength detector.

53. A method according to claim 50, wherein the detection signal encodes a detection amplitude, and the method further comprises comparing the detection amplitude with a detection threshold to determine the transition between one region and the next.

54. A method according to claim 52, further comprising changing the detection threshold in dependence on the detection amplitude.

55. A method of calibrating a printer for use with a printer consumable material, the printer consumable material including a substantially transparent substrate and a plurality of regions of printable material embedded on the substrate, each of the regions being coloured a particular colour, the printer comprising a print unit for imprinting the printable material onto a print medium, the print unit being arranged such that, in use, the substrate passes through the print unit in a defined printer consumable feed path, an emitter for selectively emitting a plurality of wavelengths of electromagnetic radiation, the emitter being arranged on a first side of the printer consumable feed path, a detector for detecting the emitted electromagnetic radiation, the detector being arranged on a second side of the printer consumable feed path and outputting a detection signal, and a print controller for controlling the print unit, the emitter and the detector, and receiving the detection signal, the method comprising:
iterating for a number of times through the steps of:
selecting a wavelength from the plurality of wavelengths of electromagnetic radiation, the selected wavelength being selected in a cyclic fashion;
controlling the emitter to emit the selected wavelength;
storing the detection signal received from the detector; and
advancing the substrate of the printer consumable material; and
processing the stored detection signals to calculate at least one detection threshold for detecting transitions between the different regions of the substrate.

56. A method according to claim 55, further comprising processing the stored detection signals using a statistical cluster analysis.

57. A method according to claim 55, further comprising:
selecting a wavelength from the plurality of wavelengths of electromagnetic radiation;
controlling the emitter to emit the selected wavelength; and
processing the detection signal in dependence on said at least one detection threshold to calculate the colour of the region between the emitter and the detector.

58. A method according to claim 55, wherein the detection signal encodes a detection amplitude, and the method further comprises comparing the detection amplitude with a said detection threshold to determine the transition between one region and the next.

59. A method according to claim 55, further comprising restarting a calibration sequence in response to a predefined event.

60. (canceled)

61. A printer, comprising
means for printing on a print medium;
means for reversing the print medium to allow double-sided printing onto the print medium;
means for storing printer configuration data, the printer configuration data including data specifying whether or not the printer is permitted to operate in a double-sided printing mode;
means for receiving an instruction to permit the operation of the printer in a double-sided printing mode; and
means for controlling the print unit and the print media rotation unit, the means for controlling being programmed to operate the printer in either a single-sided or double-sided mode in dependence on the printer configuration data, and to update the printer configuration data appropriately in response to receiving the instruction to permit the operation of the printer in a double-sided printing mode.

62. A printer, comprising
means for printing on a print medium, including a first means for gripping the print medium during printing; and
means for reversing the print medium to allow double-sided printing onto the print medium, the means for reversing including a second means for gripping the print medium while it is being reversed,
wherein the second means for gripping is arranged additionally to grip the print medium while the means for printing is operating.

63. A printer, comprising:
means for imprinting printer consumable material onto a print medium, the means for printing being arranged such that, in use, the print medium passes through the means for printing in a defined print path;
means for emitting electromagnetic radiation, arranged on a first side of the print path;
means for detecting electromagnetic radiation, arranged on a second side of the print path and outputting a detection signal; and
means for controlling the printer,
wherein the print medium has a first opacity to the electromagnetic radiation, and the print medium with the printer consumable material imprinted on it has a second opacity to the electromagnetic radiation, and
the means for controlling is adapted to set the power of the means for emitting to one of a first power level and a second power level in dependence on the first opacity and second opacity, such that when the means for emitting is set to the first power level the means for detecting can detect the presence or absence of the print medium, and when the means for emitting is set to the second power level the means for detecting can detect the presence or absence of the printer consumable material on the print medium.

64. A printer, comprising:
means for printing on a print medium;
means for reversing the print medium to allow double-sided printing onto the print medium, the means for reversing including means for gripping the print medium while it is being reversed, and
means for manually feeding a print medium into the means for gripping the print medium, to allow a user to feed a print medium into the means for reversing.

65. A printer for use with a printer consumable material, the printer consumable material including a substantially transparent substrate and a plurality of regions of printable material embedded on the substrate, each of the regions being coloured a particular colour, and the printer comprising:
means for imprinting the printable material onto a print medium, the means for printing being arranged such that, in use, the substrate passes through the means for printing in a defined printer consumable feed path;
means for selectively emitting a plurality of wavelengths of electromagnetic radiation, the means for selectively emitting being arranged on a first side of the printer consumable feed path;
means for detecting the plurality of wavelengths of electromagnetic radiation, the means for detecting being arranged on a second side of the printer consumable feed path and outputting a detection signal; and
means for controlling the means for printing, the means for selectively emitting and the means for detecting the plurality of wavelengths, and for receiving the detection signal,
wherein the means for controlling is adapted to:
select a wavelength from the plurality of wavelengths of electromagnetic radiation;
control the means for selectively emitting to emit the selected wavelength; and
process the detection signal to calculate the colour of the region between the means for selectively emitting and the means for detecting a plurality of wavelengths.

66. A printer for use with a printer consumable material, the printer consumable material including a substantially transparent substrate and a plurality of regions of printable material embedded on the substrate, each of the regions being coloured a particular colour, and the printer comprising:
means for imprinting the printable material onto a print medium, the means for printing being arranged such that, in use, the substrate passes through the print unit in a defined printer consumable feed path;
means for selectively emitting a plurality of wavelengths of electromagnetic radiation, the means for selectively emitting being arranged on a first side of the printer consumable feed path;
means for detecting the plurality of wavelengths of emitted electromagnetic radiation, the means for detecting being arranged on a second side of the printer consumable feed path and outputting a detection signal; and
means for controlling the means for printing, the means for selectively emitting and the means for detecting a plurality of wavelengths, and for receiving the detection signal,
wherein the means for controlling is adapted to carry out a calibration sequence including the steps of:
iterating for a number of times through the steps of:
selecting a wavelength from the plurality of wavelengths of electromagnetic radiation, the selected wavelength being selected in a cyclic fashion;
controlling the means for selectively emitting to emit the selected wavelength;
storing the detection signal received from the means for detecting a plurality of wavelengths; and
advancing the substrate of the printer consumable material; and
processing the stored detection signals to calculate at least one detection threshold for detecting transitions between the different regions of the substrate.

67. (canceled)

68. A carrier medium carrying computer readable code for controlling a processor in a printer to operate the printer; the code comprising code for controlling the printer to operate in either a single-sided or double-sided printing mode in dependence on printer configuration data; and code to control the printer to update the printer configuration data appropriately in response to receiving an instruction to permit the operation of the printer in a double-sided printing mode.

69. (canceled)

70. (canceled)

71. A carrier medium according to claim 68, wherein the code includes code for controlling the processor to receive the instruction from a computer-readable tag in a printer consumable package.
